(19) United States
(12) Patent Application Publication
(10) Pub. No.: US 2002/0169566 A1
(43) Pub. Date: Nov. 14, 2002

(54) Systems, methods and computer program products for determining parameters for chemical synthesis and for supplying the reagents, equipment and/or chemicals synthesized thereby

(76) Inventors: Robin Young Smith, Raleigh, NC (US); William Brian Ballard, Durham, NC (US); David Albert Coleman, San Francisco, CA (US)

Correspondence Address: MYERS BIGEL SIBLEY & SAJOVEC, PO BOX 37428, RALEIGH, NC, 27627, US

(21) Appl. No.: 10/059,818

(22) Filed: Jan. 29, 2002

Related U.S. Application Data
(63) Continuation-in-part of application No. 09/772,229, filed on Jan. 29, 2001.

(51) Int. Cl. G06G 7/48; G06G 7/58; G06F 19/00; G01N 31/00; G06F 17/60

(52) U.S. Cl. 702/22; 703/12; 705/28

(57) ABSTRACT

In response to a user query that identifies a target chemical, a listing is displayed of reagent chemicals that are used to synthesize the target chemical. A listing also is displayed of equipment that is used to synthesize the target chemical. A listing also is displayed of a procedure that is used to synthesize the target chemical by reacting the reagent chemicals in the equipment according to the procedure. User input is accepted to electronically order the reagent chemicals that are used to synthesize the target chemical, the target chemical itself and/or the equipment that is used to synthesize the target chemical. In response, a transaction is performed to electronically order the reagent chemicals that are used to synthesize the target chemical, the equipment that is used to synthesize the target chemical and/or the target chemical itself. Prior to accepting a user identification of a target chemical, a database is populated with target chemicals, corresponding listings of reagent chemicals, corresponding listings of equipment, and corresponding listings of procedures. The database then is searched in response to a user identification of a target chemical. Boolean searching, reaction triages, reaction flowcharts and/or predictive chemistry also may be provided.

### CROSS-REFERENCE TO RELATED APPLICATION

This application is a continuation-in-part of U.S. application Ser. No. 09/772,229, filed Jan. 29, 2001, entitled Systems, Methods and Computer Program Products for Determining Parameters for Chemical Synthesis and for Supplying the Reagents, Equipment and/or Chemicals Synthesized Thereby, assigned to the assignee of the present invention, the disclosure of which is hereby incorporated herein by reference in its entirety as if set forth fully herein.

### FIELD OF THE INVENTION

This invention relates to data processing systems, methods and computer program products, and more particularly to systems, methods and computer program products for chemical synthesis.

### BACKGROUND OF THE INVENTION

Chemicals are synthesized for various applications in commercial and academic environments. In chemical synthesis, a plurality of reagent chemicals are used to synthesize a target chemical, by reacting the reagent chemicals in predefined equipment according to a predefined procedure. The reagent chemicals, the target chemical, the equipment and the procedure provide the parameters for chemical synthesis.

The identification of the reagent chemicals, the equipment and the procedures to synthesize the target chemical may be contained within laboratory notebooks that are maintained by a commercial or academic organization. Moreover, the open literature also contains many references that can identify reagent chemicals, equipment and procedures that can be used to synthesize a target chemical. As one example, see Wolfe et al., Highly Active Palladium Catalysts for Suzuki Coupling Reaction, J. Am. Chem. Soc., Vol. 121, 1999, pp. 9550-9561. In the “Experimental Section” of this publication, various procedures are described for synthesizing aryl halides.

Unfortunately, it may be difficult to find an appropriate procedure for synthesizing a desired target chemical, and it also may be difficult and/or time consuming to identify and procure the reagent chemicals and/or equipment that are used to synthesize the desired target chemical.

### SUMMARY OF THE INVENTION

Embodiments of the present invention comprise systems, methods and computer program products for determining parameters for chemical synthesis in response to a user query that identifies a target chemical. In response to the user identification of the target chemical, a listing is displayed of reagent chemicals that are used to synthesize the target chemical. A listing also is displayed of equipment that is used to synthesize the target chemical. A listing also is displayed of a procedure that is used to synthesize the target chemical by reacting the reagent chemicals in the equipment according to the procedure.

In other embodiments, user input is accepted to electronically order the reagent chemicals that are used to synthesize the target chemical, the target chemical itself, and/or the equipment that is used to synthesize the target chemical. In response, a transaction is performed to electronically order the reagent chemicals that are used to synthesize the target chemical, the equipment that is used to synthesize the target chemical and/or the target chemical itself.

In yet other embodiments, prior to accepting a user identification of a target chemical, a database is populated with a plurality of target chemicals, a plurality of corresponding listings of reagent chemicals, a plurality of corresponding listings of equipment and a plurality of corresponding listings of procedures. The database then is searched in response to a user identification of a target chemical. Thus, in embodiments of the present invention, target chemicals, their reagent chemicals, their equipment and their synthesis procedures may be entered into a database and may be queried by a user. Once identified, the reagent chemicals, the target chemicals, and/or the equipment may be electronically ordered.

It will be understood that various combinations of data entry, user queries and transactions that were described above also may be provided according to embodiments of the present invention. Thus, for example, user identification of the target chemical may be provided to a preexisting database that can display a listing of reagent chemicals, a listing of equipment and a listing of a procedure. Moreover, a database may be provided which comprises a plurality of target chemicals, a plurality of corresponding listings of reagent chemicals, a plurality of corresponding listings of equipment and a plurality of corresponding listings of procedures. Alternatively, reagent chemicals that are used to synthesize a target chemical and/or equipment that is used to synthesize a target chemical may be ordered from an electronically displayed listing of the reagent chemicals, the equipment and the procedure, in response to user input. Other subcombinations also may be provided.

Other embodiments of the invention can allow for reaction triage by displaying a list of target chemicals and an indication that a plurality of procedures may be used to synthesize at least one of the target chemicals. A user selection is accepted to scroll the plurality of procedures that may be used to synthesize at least one of the target chemicals. The user selection of a procedure from the plurality of procedures then is accepted. Thus, large numbers of procedures may be scrolled to identify a procedure of interest.

Still other embodiments of the invention can provide reaction flowcharts that can indicate connected chemistries. In particular, these embodiments can display a flowchart that graphically indicates first reagent chemicals that are used to synthesize a target chemical, second reagent chemicals that are used to synthesize the first reagent chemicals, third reagent chemicals that are used to synthesize the second reagent chemicals, etc. The flowchart also graphically indicates procedures that are used to synthesize the second reagent chemicals from the third reagent chemicals, the first reagent chemicals from the second reagent chemicals, the target chemical from the first reagent chemicals, etc.

In some embodiments, the flowchart comprises a plurality of nodes that are linked by branches. A respective node corresponds to the target chemical, a first reagent chemical, a second reagent chemical, a third reagent chemical, etc. A respective branch corresponds to a procedure that is used to synthesize the target chemical, the first reagent chemical, the second reagent chemical, the third reagent chemical, etc., which corresponds to a node that is linked to the respective branch. In other embodiments, a respective branch corresponds to the target chemical, a first reagent chemical, a second reagent chemical, a third reagent chemical, etc. A respective node corresponds to a procedure that is used to synthesize the target chemical, the first reagent chemical, the second reagent chemical, the third reagent chemical, etc., which corresponds to a branch that is linked to the respective node. Accordingly, connected chemistries may be graphically illustrated.

Yet other embodiments of the invention allow searching for similar reactions and/or predictive chemistry that can identify reactions based upon similar known reactions. In these embodiments, after accepting a user identification of a target chemical, a determination is made that a procedure is not available for synthesizing the target chemical. A procedure is identified that may be used to synthesize a constituent part of the target chemical and/or a chemical that is similar to the target chemical. The procedure that is identified is modified to obtain a predicted procedure that may be used to synthesize the target chemical. A listing of reagent chemicals that may be used to synthesize the target chemical, a listing of equipment that may be used to synthesize the target chemical and a listing of the predicted procedure that may be used to synthesize the target chemical by reacting the reagent chemicals in the equipment according to the predicted procedure then may be displayed in response to the user identification of the target chemical.

### BRIEF DESCRIPTION OF THE DRAWINGS

FIGS. 1A-1G are block diagrams of systems, methods and/or computer program products according to embodiments of the present invention.

FIG. 2 is a diagram of computer systems that can practice methods and/or include computer program products according to embodiments of the present invention.

FIG. 3 is a flowchart of data entry according to embodiments of the present invention.

FIGS. 4-14 illustrate displays that may be used for data entry according to embodiments of the present invention.

FIG. 15 is a flowchart of entering properties according to embodiments of the present invention.

FIG. 16 illustrates a display that may be used to enter a reference according to embodiments of the present invention.

FIG. 17 is a flowchart of operations for performing user queries according to embodiments of the present invention.

FIGS. 18 and 19 illustrate displays that may be used for performing queries according to embodiments of the present invention.

FIGS. 20 and 21 illustrate displays of listings of reagent chemicals, equipment and procedures according to embodiments of the present invention.

FIG. 22 is a flowchart of scaling of listings according to embodiments of the present invention.

FIG. 23 is a flowchart of transactions according to embodiments of the present invention.

FIG. 24 illustrates a display that may be used for Boolean searching according to embodiments of the present invention.

FIG. 25 illustrates a display that may be used for structure/substructure searching according to embodiments of the present invention.

FIG. 26 is a flowchart of operations that may be used to perform reaction triage according to embodiments of the present invention.

FIG. 27 is a flowchart that may be used to perform reaction triage according to embodiments of the present invention.

FIG. 28 illustrates a display of a reaction view flowchart according to embodiments of the present invention.

FIG. 29 is a flowchart of operations that may be used to perform predictive chemistry according to embodiments of the present invention.

FIGS. 30A-30C and 31 are examples of predictive chemistry according to embodiments of the present invention.

### DETAILED DESCRIPTION OF PREFERRED EMBODIMENTS

The present invention now is described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout the description of the drawings.

As also will be appreciated by one of skill in the art, the present invention may be embodied as methods, data processing systems, and/or computer program products. Accordingly, the present invention may take the form of an entirely hardware embodiment, an entirely software embodiment running on general purpose hardware or an embodiment combining software and hardware aspects. Furthermore, the present invention may take the form of a computer program product on a computer-usable storage medium having computer-usable program code embodied in the medium. Any suitable computer readable medium may be utilized including hard disks, CD-ROMs, optical storage devices, or magnetic storage devices.

Computer program code for carrying out operations of the present invention may be written in an object oriented programming language such as JAVA®, Smalltalk or C++. The computer program code for carrying out operations of the present invention may also be written in a conventional procedural programming language, such as “C”. Microsoft Active Server Pages (ASP) technology and Java Server Pages (JSP) technology may be utilized. Software embodiments of the present invention do not depend on implementation with a particular programming language. The program code may execute entirely on one or more Web servers and/or application servers, or it may execute partly on one or more Web servers and/or application servers and partly on a remote computer (i.e., a user's Web client), or as a proxy server at an intermediate point in a network. In the latter scenario, the remote computer may be connected to the Web server through a LAN or a WAN (e.g., an intranet), or the connection may be made through the Internet (e.g., via an Internet Service Provider).

The present invention is described below with reference to block diagram and flowchart illustrations of methods, apparatus (systems) and computer program products according to embodiments of the invention. It will be understood that each block of the block diagrams and/or flowchart illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create structures for implementing the functions specified in the block diagram and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function specified in the block diagram and/or flowchart block or blocks.

The computer program instructions may also be loaded onto a computer or other programmable data processing apparatus to cause a series of operational steps to be performed on the computer or other programmable apparatus to produce a computer implemented process or method such that the instructions which execute on the computer or other programmable apparatus provide steps for implementing the functions specified in the block diagram and/or flowchart block or blocks.

In order to provide a complete description of preferred embodiments of the invention in a systematic manner, an overview first will be provided. Detailed embodiments of the invention then will be described.

Overview

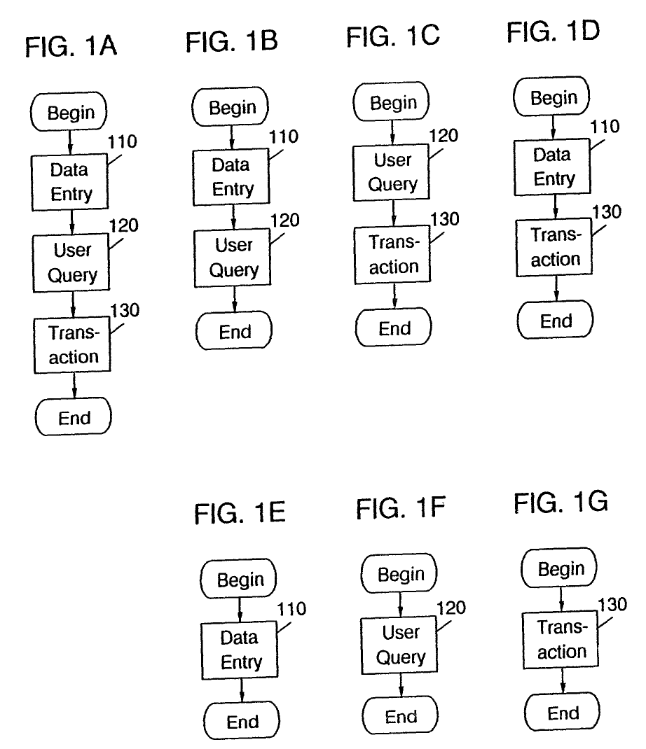

Referring now to FIGS. 1A-1G, block diagrams of systems, methods and/or computer program products according to embodiments of the present invention are shown. In embodiments of FIG. 1A, data entry 110 is provided, wherein a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure, are entered into a database. At Block 120, a user query that identifies a target chemical is accepted, and a listing of reagent chemicals that are used to synthesize the target chemical, a listing of equipment that is used to synthesize the target chemical, and a listing of the procedure that is used to synthesize the target chemical by reacting the reagent chemicals in the equipment according to the procedure, is displayed in response to the user identification of the target chemical. Finally, at Block 130, a transaction accepts a user input to electronically order the reagent chemicals that are used to synthesize the target chemical, the target chemical itself and/or the equipment that is used to synthesize the target chemical, and the reagent chemicals, target chemical and/or the equipment is electronically ordered in response to the user input.

As shown in FIGS. 1B-1D, various combinations of data entry 110, user query 120 and transactions 130 may be provided according to embodiments of the present invention. Thus, for example, in FIG. 1B, data entry 110 is provided to enter into a database, a plurality of target chemicals, a plurality of corresponding listings of reagent chemicals, a plurality of corresponding listings of equipment, and a plurality of corresponding listings of procedures. A user query 120 then may be performed by accepting a user identification of a target chemical, and displaying the corresponding listing of reagent chemicals, equipment and procedure. In embodiments of FIG. 1B, transactions need not be performed electronically. Moreover, in FIG. 1C, a user query 120 of a preexisting database may be provided wherein, in response to a user identification of a target chemical, a display of a listing of reagent chemicals, a listing of equipment and a listing of a procedure is provided. At Block 130, a transaction then may be performed to electronically order the reagent chemicals, the target chemical, and/or the equipment. Finally, in FIG. 1D, data entry 110 is provided to enter into a database target chemicals, corresponding reagent chemicals, corresponding equipment and corresponding procedures, and then a transaction 130 may be performed from the database without a query.

As also shown in FIGS. 1E-1G, data entry 110, user query 120 and transactions 130 may be used separately according to embodiments of the present invention. Thus, in FIG. 1E, data entry 110 may be used to populate a database of a plurality of target chemicals, a plurality of corresponding listings of reagent chemicals, a plurality of corresponding listings of equipment and a plurality of corresponding listings of procedures. This database may include three related databases: a chemical database, an equipment database and a supplier database. As part of data entry, a plurality of target chemicals, a plurality of first pointers to a corresponding plurality of listings of reagent chemicals in the chemical database, a plurality of second pointers to a corresponding plurality of listings of equipment in the equipment database, and a plurality of corresponding listings of procedures are entered into the chemical database. The plurality of listings of equipment are entered into the equipment database, along with a plurality of third pointers to a corresponding plurality of listings of equipment suppliers in the supplier database. The listings of equipment suppliers are entered into the supplier database. This database or databases may be used as was described in FIGS. 1A, 1B and 1D, and/or for other purposes, such as archival purposes.

As part of data entry, a narrative description of steps of the corresponding procedure may be interactively generated and entered into a database, using the corresponding listing of the reagent chemicals and the corresponding listing of equipment. In particular, user entry of a listing of reagent chemicals that are used in a next step of a procedure to synthesize a target chemical, user entry of a listing of corresponding equipment that is used in the next step, and user entry of the next step may be accepted in response to user indication that the next step is present in the procedure. The target chemical, reagent chemicals, equipment and procedures may be obtained from a publication related to synthesis of the target chemical and/or from proprietary data related to synthesis of the target chemical, for example in lab notebooks.

Moreover, as shown in FIG. 1F, user queries 120 of preexisting databases may be performed to accept a user identification of a target chemical and display a corresponding listing of reagent chemicals, equipment and a procedure. In embodiments of user queries, the user may identify the target chemical by formula, chemical structure, chemical compound name and/or CAS number. Moreover, in response to a user query, a listing of target chemicals that match the user query may be displayed, and a user selection of a target chemical from the listing of target chemicals may be accepted. The listing of target chemicals may be prioritized, based, for example, on the extent of match to the user query. The listings of reagent chemicals, equipment and procedures corresponding to the user-selected target chemical then may be displayed. In yet other embodiments, a user identification of a reaction type may be accepted, and a listing of target chemicals that are synthesized using the reaction type may be displayed. A user selection of a target chemical then may be accepted from the listing of target chemicals.

In yet other query embodiments, backward searching may be performed. In particular, a listing of procedures that can be used to synthesize a target chemical may be displayed in response to a user identification of the target chemical. A user selection of a procedure from the listing of procedures may be accepted, and the listing of reagent chemicals, equipment and the procedure may be displayed in response to the user selection of the procedure. In other query embodiments, forward searching may be performed. In particular, a listing of procedures is displayed that use the target chemical as a reagent chemical, in response to user identification of the target chemical. A user selection of a procedure is accepted. In still other query embodiments, after accepting a user identification of a target chemical, a user selection of a desired quantity of the target chemical is accepted. The listing of the reagent chemicals then is scaled, so as to synthesize the desired quantity of the target chemical. Then, a scaled listing of reagent chemicals, a listing of equipment that is used to synthesize the desired quantity of the target chemical and the listing of the procedure that is used to synthesize the desired quantity of the target chemical is displayed.

Finally, referring to FIG. 1G, transactions 130 may be performed independently by electronically ordering the target chemicals, reagent chemicals that are used to synthesize the target chemical and/or equipment that is used to synthesize the target chemical from an electronically displayed listing of the reagent chemicals, of the equipment and of a procedure, in response to user input. In some embodiments of transactions 130, a kit of reagent chemicals that are used to synthesize the target chemical is ordered. In other embodiments, a kit of the equipment that is used to synthesize the target chemical is ordered. Both kits also may be ordered. In yet other embodiments, the target chemical itself is ordered.

Detailed Embodiments

Some embodiments of the present invention may be practiced on a single computer, for example using a client-server architecture. However, because other embodiments of the present invention may involve storage and/or searching of large numbers of target chemicals and their corresponding reagent chemicals, equipment and procedures, embodiments of the present invention may be implemented on a client-server system, wherein at least one client computer and at least one server computer are connected over a network, such as the Internet.

The Internet is a worldwide decentralized network of computers having the ability to communicate with each other. The Internet has gained broad recognition as a viable medium for communicating and for conducting business. The World-Wide Web (Web) was created in the early 1990's, and is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), as well as image formats such as Graphics Interchange Format (GIF) and Joint Photographic Experts Group (JPEG).

A Web site generally comprises a related collection of Web files that includes a beginning file called a “home” page. From the home page, a visitor can access other files and applications at a Web site. A large Web site may utilize a number of servers, which may or may not be different and which may or may not be geographically-dispersed. For example, the Web site of the International Business Machines Corporation (www.ibm.com) includes thousands of Web pages and files spread out over multiple Web servers in locations world-wide.

A Web server (also referred to as an HTTP server) is a computer program that generally utilizes HTTP to serve files that form Web pages to requesting Web clients. Exemplary Web servers include International Business Machines Corporation's family of Lotus Domino® servers, the Apache server (available from www.apache.org), and Microsoft's Internet Information Server (IIS), available from Microsoft Corporation, Redmond, Wash. A Web client is a requesting program that also generally utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized with the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects a particular hypertext link, a browser running on the user's client device reads and interprets an address, called a Uniform Resource Locator (URL) associated with the link, connects the browser with a Web server at that address, and makes a request (e.g., an HTTP request) for the file identified in the link. The Web server then sends the requested file to the client device which the browser interprets and renders within a display screen.

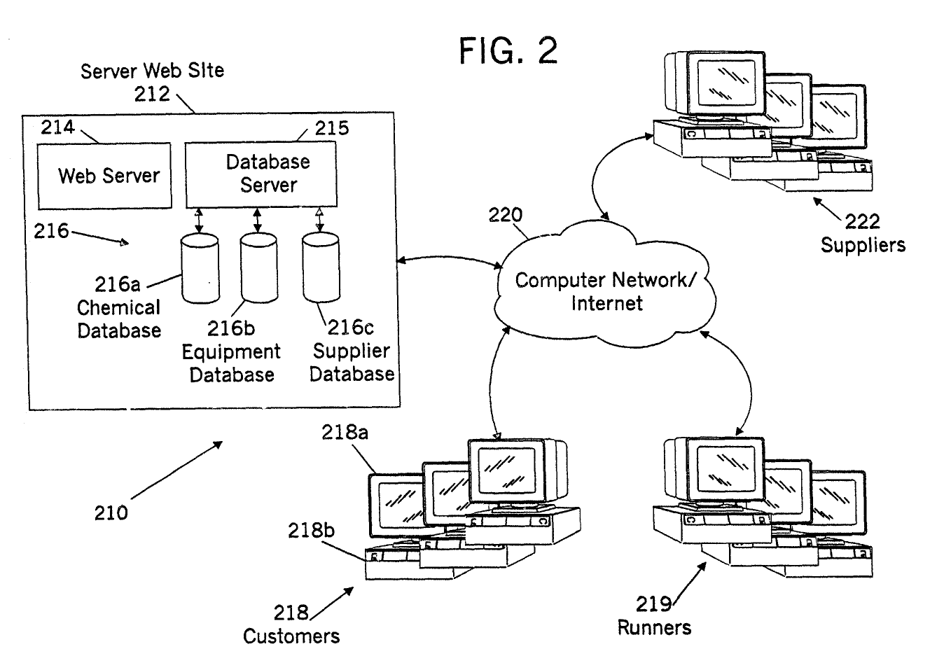

Referring now to FIG. 2, a computer system 210 that can practice methods and/or include computer program products according to embodiments of the present invention, is schematically illustrated. The illustrated system 210 includes a server Web site 212 and a plurality of users, also referred to herein as “customers”, who can perform user queries 120 of FIGS. 1A-1G and/or perform transactions 130 of FIGS. 1A-1G, and who communicate with the server Web site 212 from customer sites 218 over a computer network, such as the Internet 220. Customer sites 218 may include a computer display 218a and a computer 218b. A pointing device such as a mouse also may be included.

The server Web site 212 includes a Web server 214, such as a Java Web server, a database server 215 and one or more databases 216. As shown in FIG. 2, the databases 216 may include a chemical database 216a, an equipment database 216b and a supplier database 216c. Other databases also may be provided. Although a single Web server 214 and database server 215 are illustrated, it will be understood that multiple Web servers and multiple database servers (including other application servers) may be utilized according to embodiments of the present invention.

The Web server 214 is the “front end” component of the Web site 212, and is configured to handle requests from customer sites 218 that access the Web site 212. The Web server 214 can include program code, logic and graphics, to interface with the customer sites 218. Exemplary commercial Web servers that may be utilized as a Web server 214 in the illustrated system 210 are Apache, available from the Apache Server Project, http://www.apache.org; Microsoft's Internet Information Server (IIS), available from Microsoft Corporation, Redmond, Wash.; and Netscape's FastTrack® and Enterprise™ servers, available from America Online, Inc., Dulles, Va. Other Web servers that may be utilized include Novell's Web Server for users of its NetWare® operating system, available from Novell, Inc., San Jose, Calif.; and IBM's family of Lotus Domino® servers, available from International Business Machines Corporation, Armonk, N.Y.

As is known by those of skill in the art, a database is a collection of data that is organized in tables or other conventional forms of organization. A database typically includes a database manager and/or database server 215 that facilitates accessing, managing, and updating data within the various tables of a database. Exemplary types of databases that can be used to implement the chemical database 216a, equipment database 216b, and supplier database 216c of the present invention include relational databases, distributed databases (databases that are dispersed or replicated among different points in a network), and object-oriented databases. Relational, distributed, and object-oriented databases are well understood by those of skill in the art and need not be discussed further herein.

The database server 215 operates as a “middleman” server between the Web server 214 and the plurality of databases 216a-216c. The database server 215 generally includes program code and logic for retrieving data from the databases 216a-216c (and from sources external to the Web site 212) in response to requests from the Web server 214. Commercial database servers that may be utilized as a database server 214 in the illustrated system 210 include Microsoft's SQL server, IBM DB2® Universal Database server, the latter being available from International Business Machines Corporation, Armonk, N.Y.

FIG. 2 illustrates a plurality of databases 216 including a chemical database 216a, an equipment database 216b and a supplier database 216c. However, it will be understood that one or more of these databases may be combined into a single database and that other databases also may be provided at the server Web site 212.

Data structures of the databases 216a-216c according to embodiments of the invention now will be described. In embodiments of the invention, the chemical database 216a includes listings of a plurality of target chemicals, a plurality of first pointers to a corresponding plurality of listings of reagent chemicals in the chemicals database 216a that are used to synthesize the plurality of target chemicals, a plurality of second pointers to a corresponding plurality of listings of equipment in the equipment database 216b, and a plurality of corresponding listings of procedures that are used to synthesize the plurality of target chemicals by reacting the corresponding reagent chemicals in corresponding equipment according to the corresponding procedure. Table 1 provides an example of an architecture of a chemical database 216a according to embodiments of the present invention.

TABLE 1
Chemical Database 216a

| ATTRIBUTE | TYPE | DESCRIPTION |
|---|---|---|
| name | text | the compound name such as 4- |
| | | Acetylbiphenyl |
| id | integer | unique identifier within Table 1 |
| entered_by | text | the runner who input the data |
| first_entered | timestamp | date/time entry was first entered |
| modified_by | text | name of last person who modified this |
| | | record |
| last_modified | timestamp | date/time entry was last modified |
| ref | text | the journal references |
| image_url | text | pointer to the graphic for this compound |
| | | which is stored on the web server 214 |
| recipe | text | the protocol text |
| chemicals | integer[] | first pointers (using the ‘id’ field) to |
| | | reagents needed. Points to other records in |
| | | the chemical database 216a |
| equipment | integer[] | second pointers to records in the |
| | | equipment database 216b |
| cas | text | the CAS number |
| formula | text | the formula |
| mweight | float8 | molecular weight |
| quantity | float8[] | arrays of integers corresponding to |
| | | quantity of each equipment |
| equivalent | float8[] | equivalent of this compound |
| yield | float8 | the yield for this protocol |
| flask_name | text | the name of the flask used |
| info | text | keywords |
| density | float8 | density of this compound |
| bplo | float8 | boil point range, low end |
| bphi | float8 | boil point range, high end |
| fp | float8 | flash point |
| vp | text | vapor pressure |
| mplo | float8 | melting point, low end |
| mphi | float8 | melting point, high end |
| beilstein | text | beilstein reference |
| other_names | text | other names |
| reagents | text | list of the reagents cas #s |
| smiles | text | structure description |
| reagent smiles | text | semicolon separated structure descriptions |
| | | for the reagents |
| incompatible | text | semicolon separated incompatible |
| | | chemicals |

The equipment database 216b contains a plurality of listings of equipment that can be used to synthesize various target chemicals. Table 2 illustrates an architecture of an equipment database 216b according to embodiments of the present invention.

TABLE 2
Equipment Database 216b

| ATTRIBUTE | TYPE | DESCRIPTION |
|---|---|---|
| name | text | name of equipment |
| id | integer | unique record identifier |
| suppliers | integer[] | third pointers (‘id’ value) into the |
| | | supplier database 216c |
| unit | text | measured unit (ml, L, etc.) |
| our_price | money | our price per unit |
| om_price | money | average price for outside supplier |
| size | integer | volume (for flasks) |
| category | integer | integer describing type of item |
| 1 = flask | | |
| 2 = additional equipment | | |
| 3 = flask equipment | | |

The supplier database 216c contains a listing of suppliers of reagent chemicals and/or equipment. Table 3 is an architecture of a supplier database 216c according to embodiments of the invention.

TABLE 3
Supplier Database 216c

| ATTRIBUTE | TYPE | DESCRIPTION |
|---|---|---|
| name | text | supplier name (company name) |
| id | integer | unique record identifier |
| address1 | text | |
| address2 | text | |
| city | text | |
| state | text | |
| website | text | |
| phone | text | |
| Index: supplier_id_key | integer | unique record identifier |

The server Web site 212 is accessible to customer sites 218 via a computer network such as the Internet 220. Customers can access the server Web site 212 via a client program, such as a browser and/or a custom software application, running on a client device, such as a personal computer 218b including a display 218a. However, it will be understood that other electronic devices such as personal digital assistants (PDAs), hand-held computers, Internet-ready phones, and WebTVs, may be utilized as client devices for accessing the Web site 212 in accordance with embodiments of the present invention.

The Web server 214 also is configured to communicate with various third parties according to embodiments of the present invention. As will be described below, the Web server 214 is configured to communicate with other users, often referred to as “runners”, at runner sites 219, who perform data entry (Block 110 of FIGS. 1A-1B and 1D-1E) according to embodiments of the present invention. When using public domain sources, an “Experimental Section” may be the source of data entry as was described above with reference to the Wolfe et al. publication.

Moreover, in other embodiments, data entry may be performed within an entity, such as a corporation or university, using proprietary data that may be contained, for example, in lab notebooks. This can provide institutional memory archiving systems, methods and computer program products that can be used, for example, by large corporations or universities, to archive the results of many chemical synthesis experiments that are contained in lab notebooks. In yet other alternatives, a scientist who is involved in chemical synthesis can archive data that is being generated by the scientist during the course of chemical synthesis. Accordingly, in some embodiments, the customer sites 218 and the runner sites 219 may be combined into a single station.

Finally, the customer sites 218 may communicate with suppliers of chemicals and/or equipment at supplier sites 222, in performing a transaction 130 of FIGS. 1A, 1C-1D and 1G, via the Internet 220 and preferably through the Web server 214. Communications between the customer sites 218, runner sites 219, the server Web site 212 and supplier sites 222 are preferably established via the Internet 220. However, other communication methods and networks may be utilized, including direct-dial access and telephonic communications. Wireless or wire communications may be used.

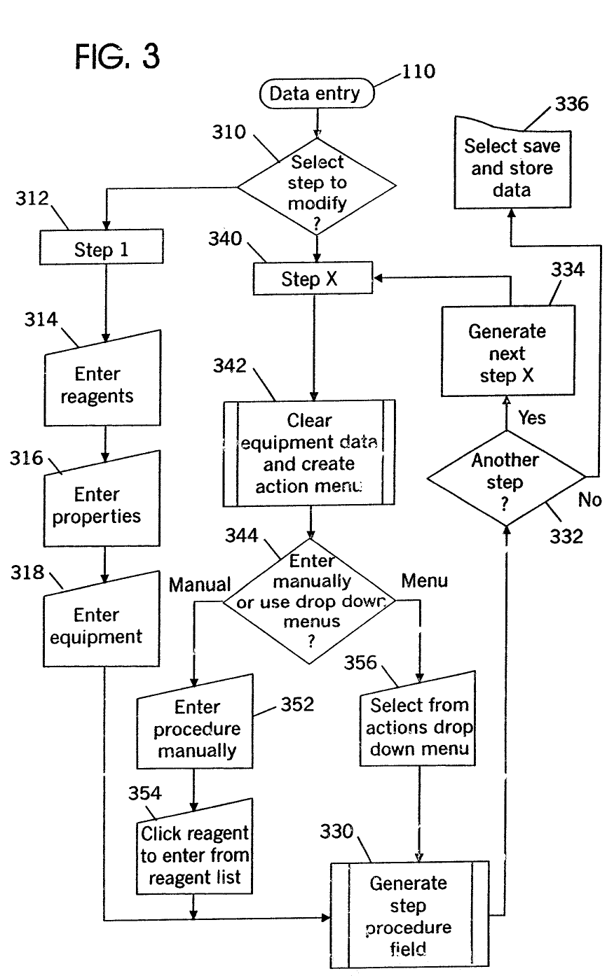

Referring now to FIG. 3, detailed operations for data entry (Block 110 of FIGS. 1A-1B and 1D-1E) now will be described. As was described above, data entry may be performed by users, also referred to herein as “runners” who may be tasked with a list of target chemicals for which to research public domain synthesis procedures and to enter these procedures in a data entry operation. The target chemicals may be derived from a list of target chemicals that are widely used in industrial and/or academic application. Target chemicals also may be identified based on user queries in a user query operation 120 of FIGS. 1A-1C and 1F, for which no target chemicals were identified. Other techniques for identifying target chemicals for database entry also may be used. Data entry operations 110 of FIG. 3 can facilitate the manual, semiautomatic or automatic entry of narrative procedures, reagent chemicals and equipment that is used to synthesize a target chemical by reacting the reagent chemicals in the equipment according to the procedure.

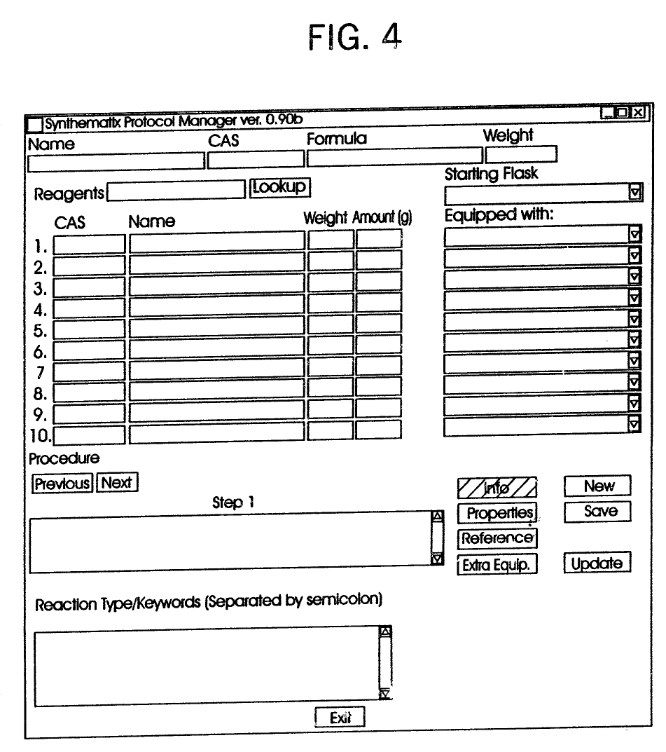

Referring now to FIG. 3, operations begin at Block 310, where the runner selects a step to modify. Thus, when entering data for a new procedure, Step 1 is selected at Block 312, for example by selecting the New button of the data entry display of FIG. 4.

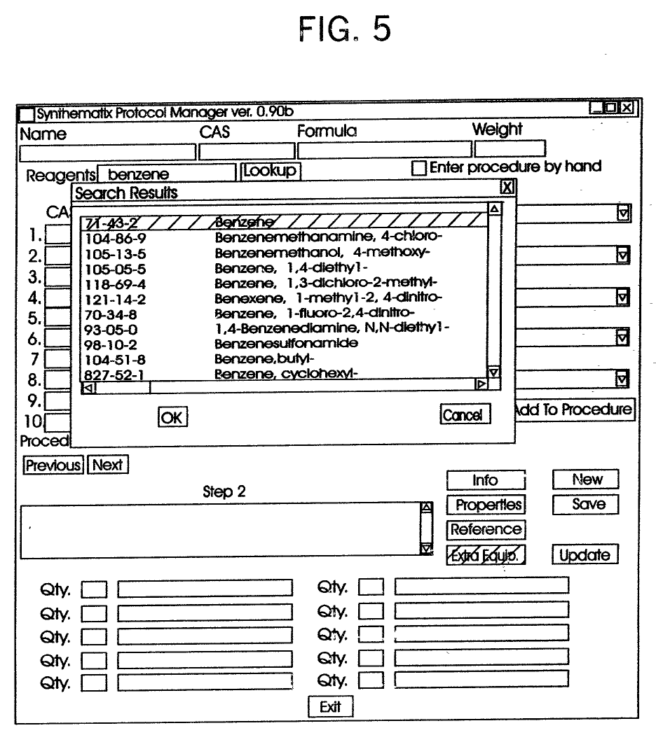

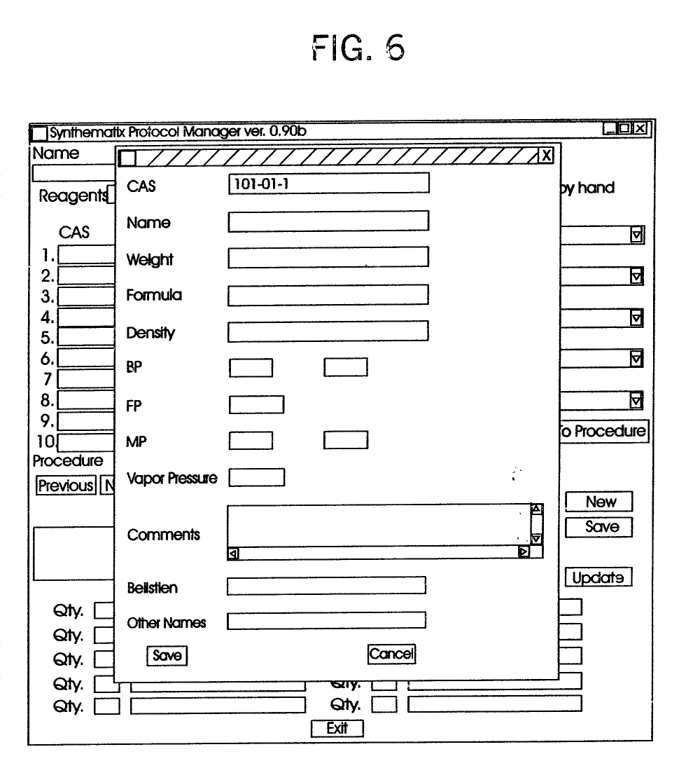

Referring to Block 314, the reagents for Step 1 are then entered. As shown in FIG. 5, reagents may be entered using a reagent lookup. Alternatively, as shown in FIG. 6, reagents may be entered via manual entry.

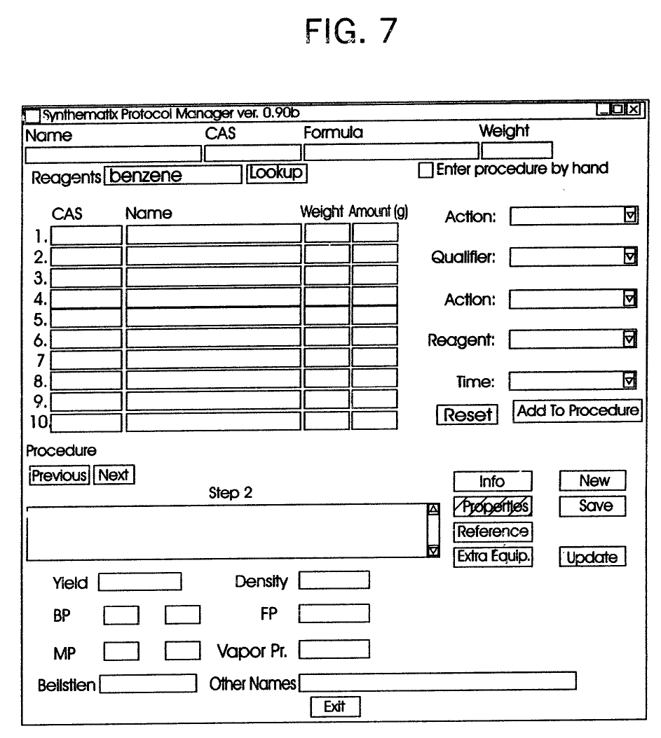

Then, referring to Block 316, various properties of the target chemical may be entered by selecting the Properties button of FIG. 7 and entering the properties shown at the bottom of FIG. 7. As shown, properties can include yield, density, boiling point (BP), flash point (FP), melting point (MP), vapor pressure, Beilstein number, other names and other properties.

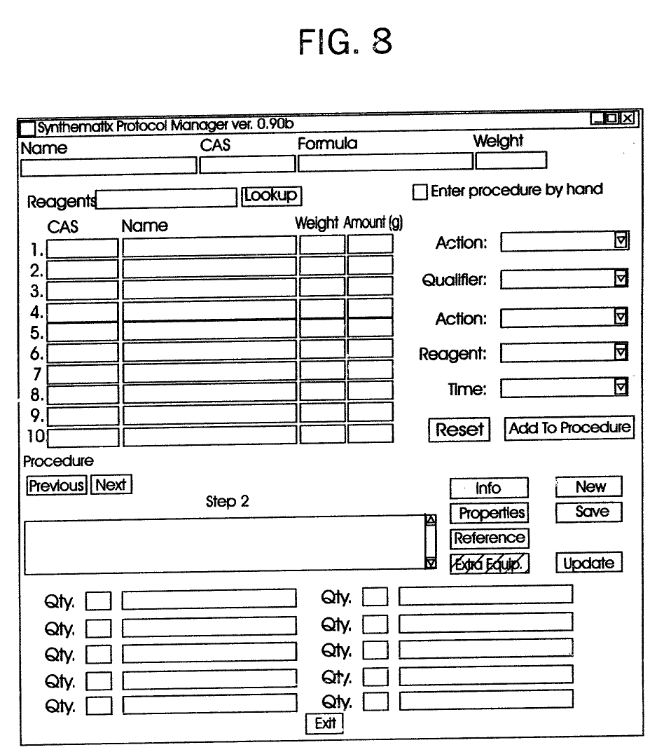

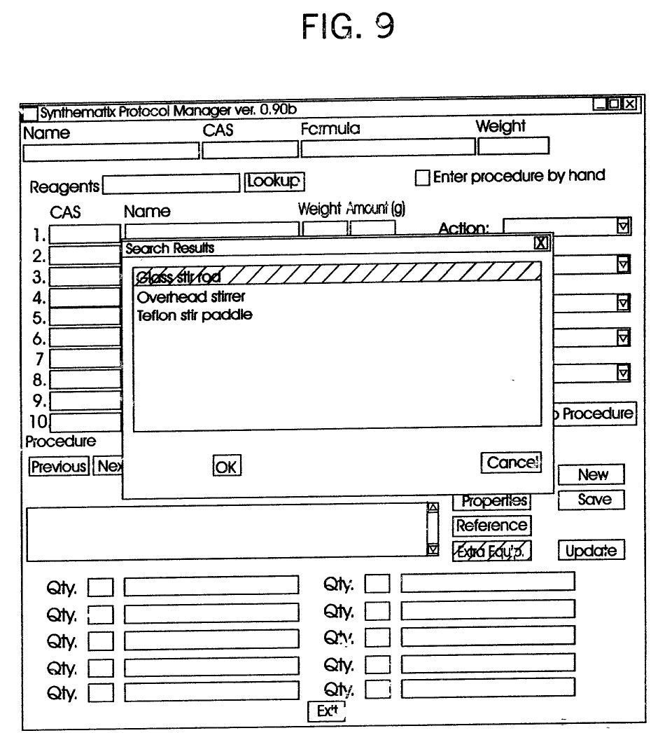

At Block 318, equipment then is entered, for example by manual entry on equipment lists as shown in FIG. 8 and/or by equipment lookup as shown in FIG. 9. It will be understood that the operations at Blocks 314, 316 and 318 may be performed in sequences that are different from that illustrated in FIG. 3.

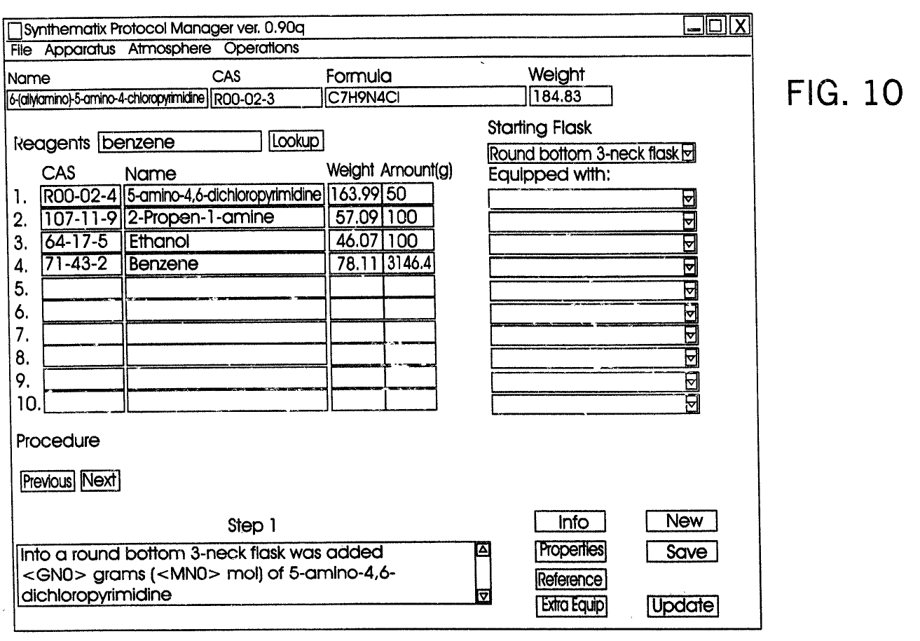

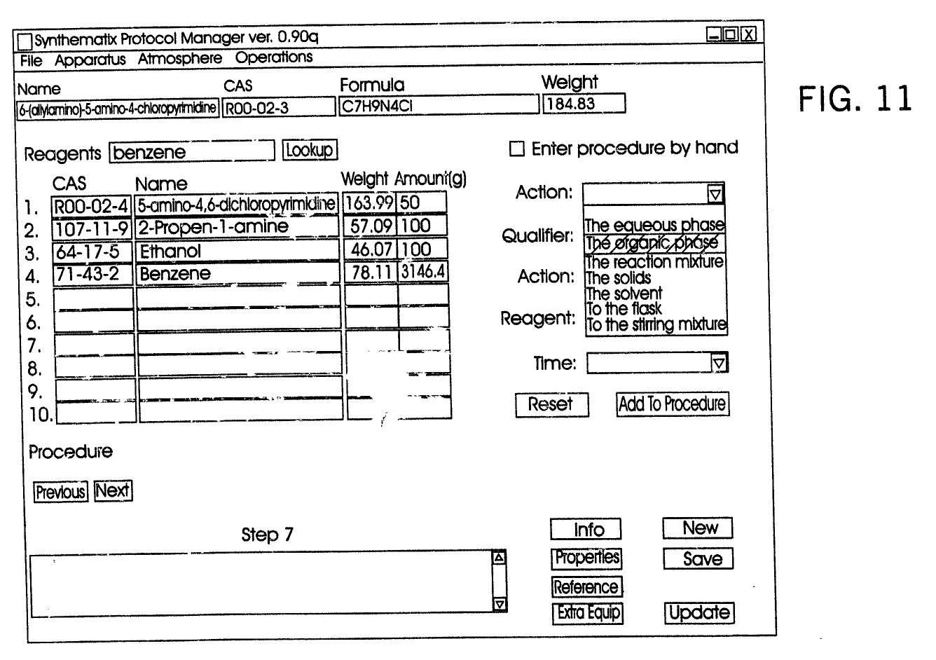

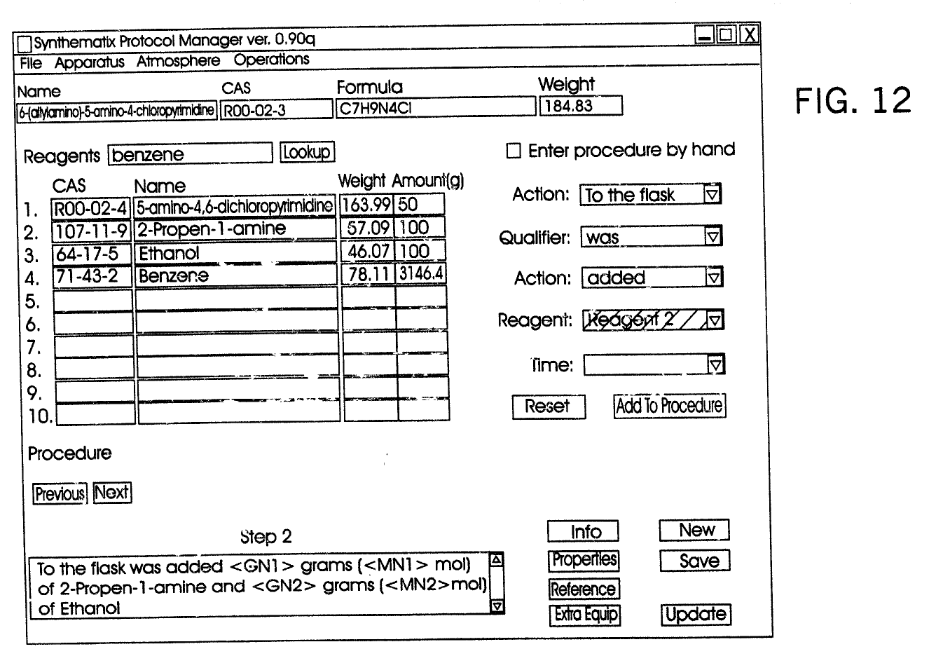

Then, referring to Block 330, the narrative for the first step of the procedure can be generated interactively, for example using the first reagent and the starting equipment, as shown in FIG. 10. FIGS. 11 and 12 illustrate other examples of generation of a step of a procedure by selecting actions, qualifiers, reagents and times using pull-down menus.

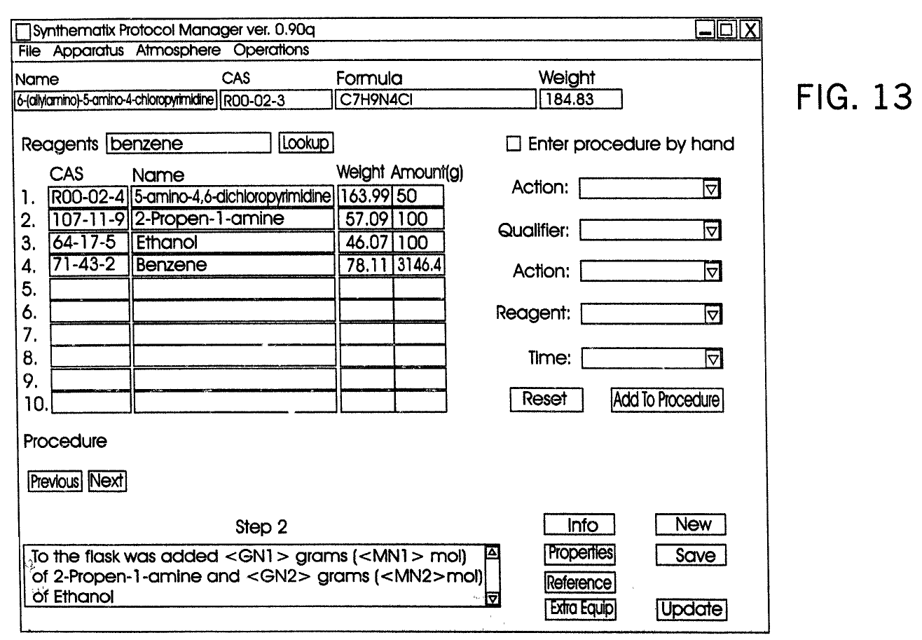

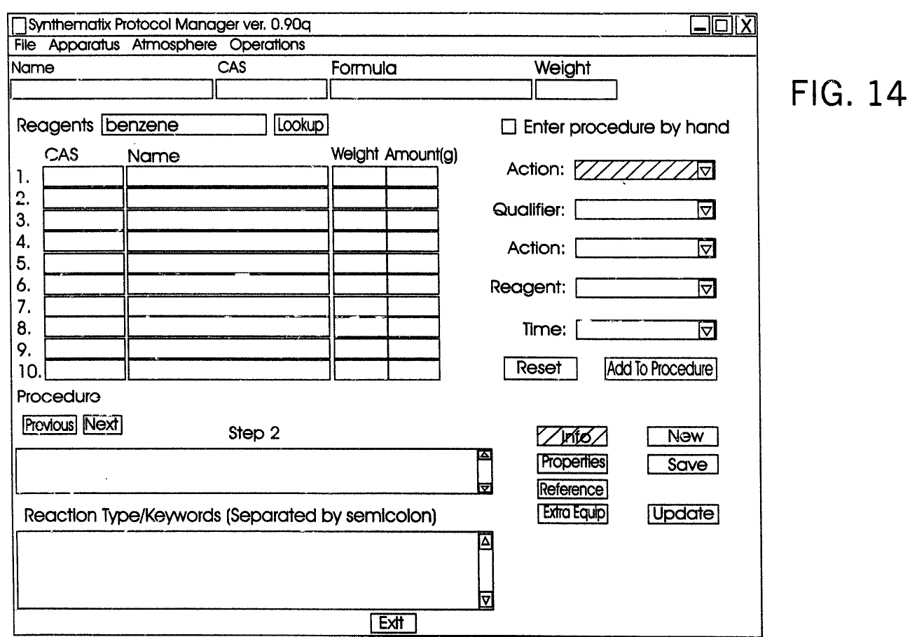

Assuming there is another step at Block 332, the next step may be selected (Block 334) by selecting the Next button as shown in FIG. 13. In particular, to generate the next step at Block 340, the equipment data is cleared and an action menu may be generated, as shown in FIG. 14. At Block 344, the runner is given the choice of entering the procedure manually or using the drop-down menu. If manually, then at Block 352, the procedure is typed in manually, and at Block 354, the reagent is entered from the reagent list by selection. Alternatively, if by drop-down menu, then the actions are selected from the drop-down menu at Block 356, for example as shown in FIG. 14.

For interactive entry, a common template for a procedure step may be provided, such as “into a _______ equipped with _______ is added _________ ”. The runner can then supply the starting flask, equipment list and first reagent using pull-down menus and/or manual entries. The specific quantities may be provided using tags for molar quantities and gram quantities. These quantities may be scaled later, as will be described below.

Returning again to FIG. 3, when the last step has been entered at Block 332, the Save button (FIG. 4) may be selected and the data may be stored (Block 336) in the chemical database 216a and the equipment database 216b of FIG. 2. In particular, the target chemicals and the reagent chemicals may be stored in the chemical database 216a that was described in Table 1. The equipment may be entered into the equipment database 216b that was described in Table 2. Supplier data also may be entered into the supplier database 216c that was described in Table 3. Supplier data can be entered directly into the database 216c using the database server 215, and/or a graphical user interface may be provided to facilitate data entry.

The databases 216a may be populated as follows: The data may be read from a product data file and may be tab delimited. Complete entries may be separated by a new line. A call is made to a Java servelet located at the server Web site 212. The servelet accepts a connection and waits for the data. The runner site 219 sends the data and waits for a reply. The servelet at the server Web site 212 reads the data and inserts it into the database 216a at each new line, using the database server 215. The entry program also sends the date/time of the last time it updated. The servelet sends any new entries into the database since that time, and all entries in the database are timestamped. The servelet sends the current date/time and the entry program saves it to a file for the next time.

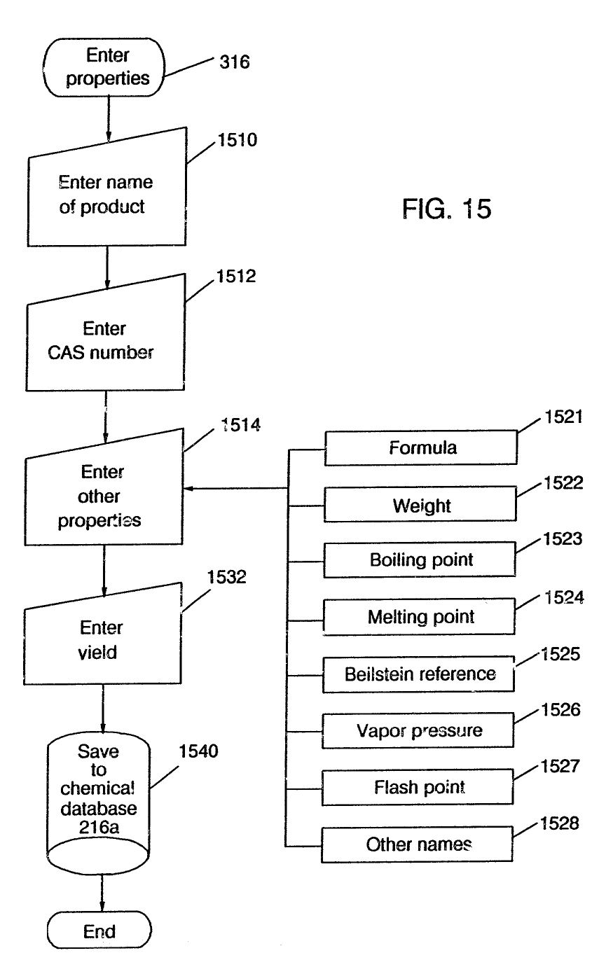

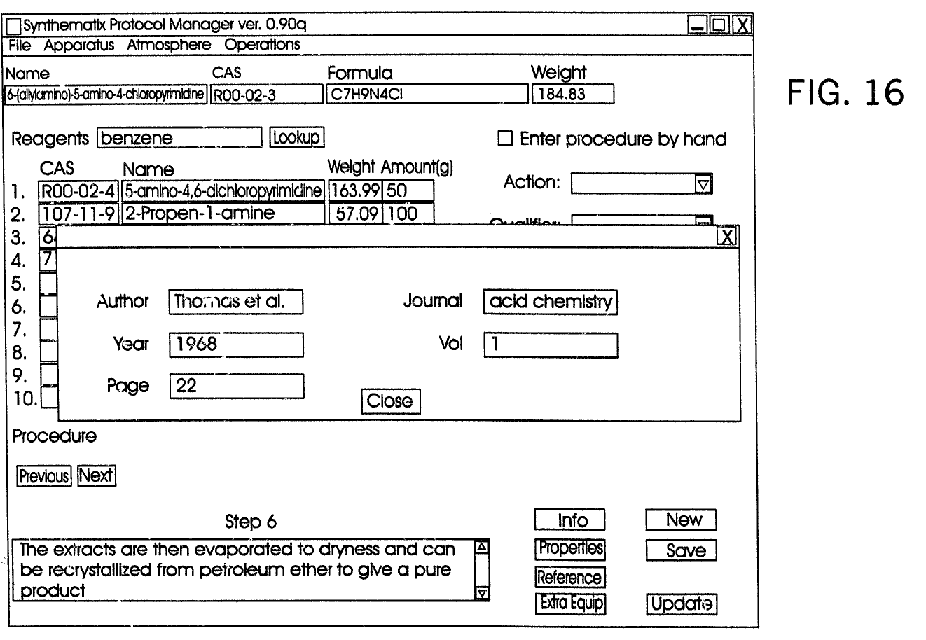

Referring now to FIG. 15, additional details for entering properties (Block 316 of FIG. 3), according to embodiments of the invention, now will be provided. As shown in FIG. 6, the name of the product can be entered in the “Name” field at Block 1510. The CAS number can be entered into the CAS field of FIG. 6 at Block 1512. Other properties may be entered at Block 1514. In particular, the formula (Block 1521) and weight (Block 1522) may be entered into the appropriate blocks of FIG. 6. The boiling point BP (Block 1523), melting point MP (Block 1524), Beilstein reference (Block 1525), vapor pressure (Block 1526), flash point (Block 1527) and other names (Block 1528) may be entered into the appropriate fields of FIG. 6. At Block 1532, the yield also may be entered into the appropriate block of FIG. 6. The Reference button of FIG. 4 also may be selected, and the reference to the publication where the procedure was obtained may be entered, for example using the pop-up window of FIG. 16. Then, at Block 1540, the information that was entered is saved into the appropriate fields of the chemical database 16a, for example using the format shown in Table 1 above.

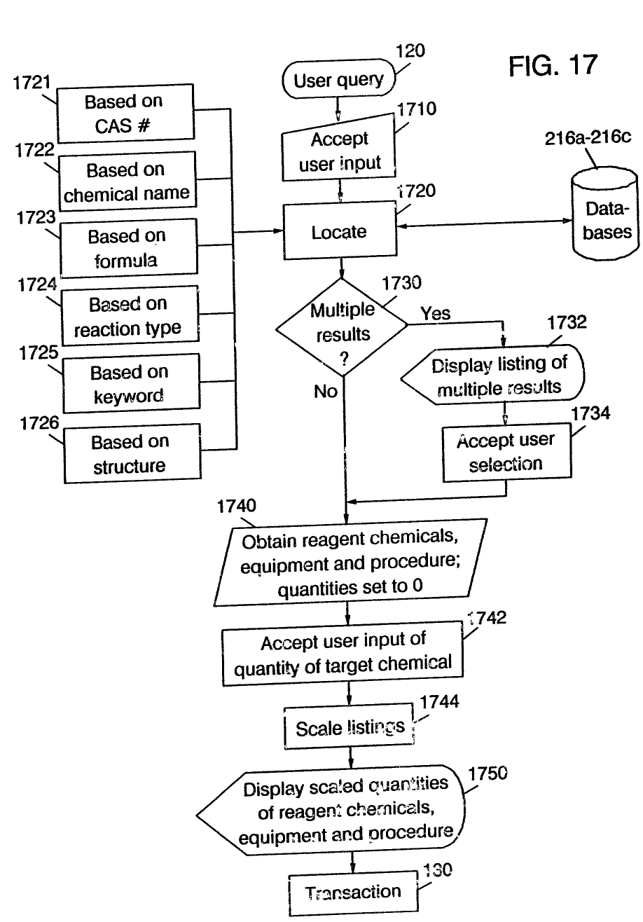

Referring now to FIG. 17, operations for performing user queries (Block 120 of FIGS. 1A-1C and 1F) now will be described in detail. As shown at Block 1710, a user identification of a target chemical is accepted. At Block 1720, a listing of reagent chemicals that are used to synthesize the target chemical, a listing of equipment that is used to synthesize the target chemical and a listing of the procedure that is used to synthesize the target chemical by reacting the reagent chemicals in the equipment according to the procedure, is located and displayed.

As shown at Blocks 1721-1726, many different query techniques may be used to identify a target chemical. In particular, a user identification of a target chemical may be obtained based on CAS number (Block 1721), chemical name (Block 1722), chemical formula (Block 1723) or chemical structure (Block 1726). Moreover, at Block 1724, the user identification of a reaction type is accepted and a listing of target chemicals that are synthesized using the reaction type is displayed. Then, a user selection of a target chemical from the listing of target chemicals that are synthesized using the reaction type is accepted. Finally, at Block 1725, user identification of a keyword may be accepted and a listing of target chemicals that are synthesized using the keyword may be displayed. A user selection of a target chemical from a listing of target chemicals that are synthesized using the keyword then is obtained. Other query techniques also may be used. Based on the input at Blocks 1721-1726, the locate operations of Block 1720 perform database searches of the databases 216a-216c of FIG. 2, for example via the database server 215.

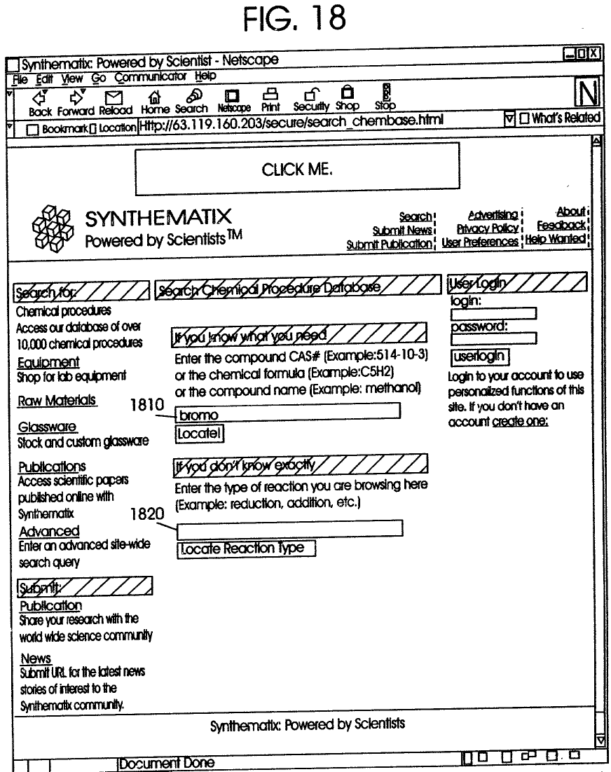

Additional details of the operations of Blocks 1710 and 1720-1726 now will be provided. FIG. 18 illustrates an example of a user display that may be displayed at a customer site 218 to accept user input at Block 1710. As shown in FIG. 18, the CAS number, chemical formula or compound name may be entered at field 1810. Upon entering data at field 1810 and activating the Locate! button, the processing of Block 1720 can first determine whether a valid CAS number is present. If yes, then a search of the databases 216a-216c may be performed based on the CAS field in Table 1. If a valid CAS number is not present, then a search may be performed on the name and formula fields of Table 1.

A user also may input a chemical structure (Block 1726) using conventional chemical drawing and/or other drawing programs. The chemical structure then may be searched by converting the chemical structure into an alphanumeric string that represents the chemical structure, for example using conventional conversion tools. For example, the SMILES tool kit, marketed by Daylight Chemical Information Systems, Inc., may be used to convert the chemical structure into an alphanumeric string using protocols that are described at www.daylight.com. In yet another alternative, an MDL tool, marketed by MDL Information Systems, Inc., may be used to convert the chemical structure into an alphanumeric string, as described at w-zww.mdli.com. Other conversion tools may be used. A search then may be performed relative to the smiles and reagent smiles attributes of the chemical database 216a, as was described in Table 1.

Still referring to FIG. 18, alternatively, if the user does not know exactly what the user is searching for, an entry may be made at field 1820 based on reaction type (Block 1724) or any other keyword (Block 1725), and the Locate Action Type button can be pressed. A search then is performed on the info, name, equivalent, other_names or other fields of the chemical database 216a, to attempt to find a match.

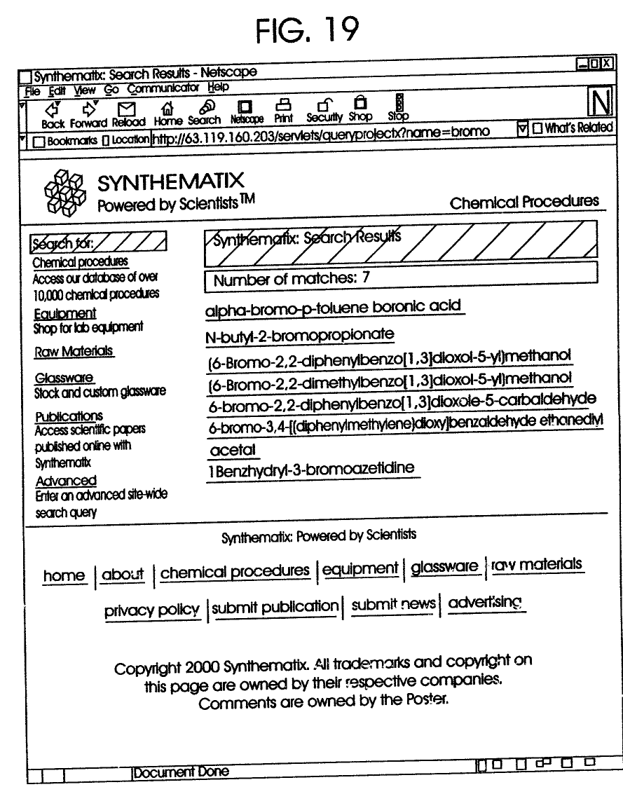

Referring now to Block 1730 of FIG. 17, a search based on CAS number (Block 1721), chemical name (Block 1722) or formula (Block 1723) may produce a single result of a match or multiple results. If a single result is produced, then the single result is displayed at Block 1740. However, a search based on reaction type (Block 1724) or keyword (Block 1725) generally will provide multiple matches at Block 1730. If multiple results are present at Block 1730, a listing of the multiple results is displayed at Block 1732. An example of a display of multiple results is shown in FIG. 19 based on a search of the chemical name “bromo” in field 1810 of FIG. 18. A user selection of one of the matches from the list is then accepted at Block 1734, and the result is displayed at Block 1740.

When multiple results are found, a prioritized listing may be displayed, so that more likely desired results are displayed at the top of the listing. In particular, in response to a user input in field 1810 of FIG. 18, the name, other_names and info attributes of the chemical database 216a may be searched. The results may be displayed in a priority sequence as follows: exact matches in the name attribute; exact matches in the other_names attribute; partial matches in the name attribute; and, finally, partial matches in the other_names attribute. By prioritizing the display of results, the more likely user selections may be displayed at the top of the list in FIG. 19.

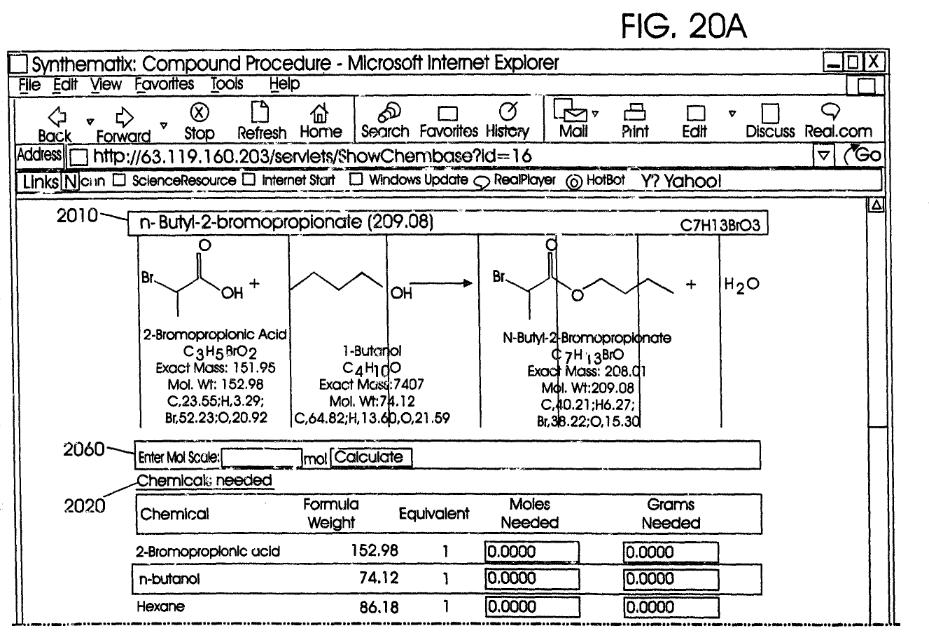

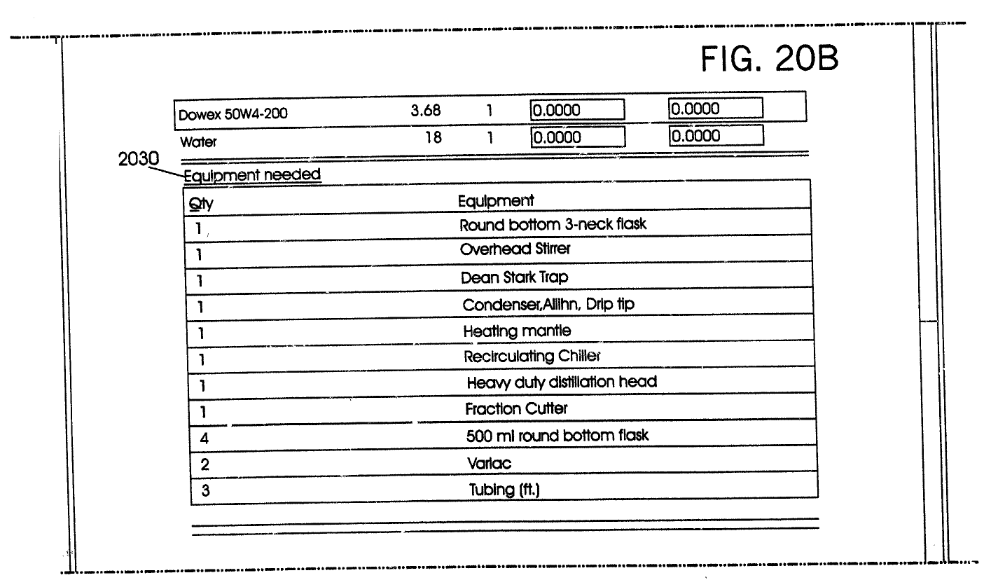

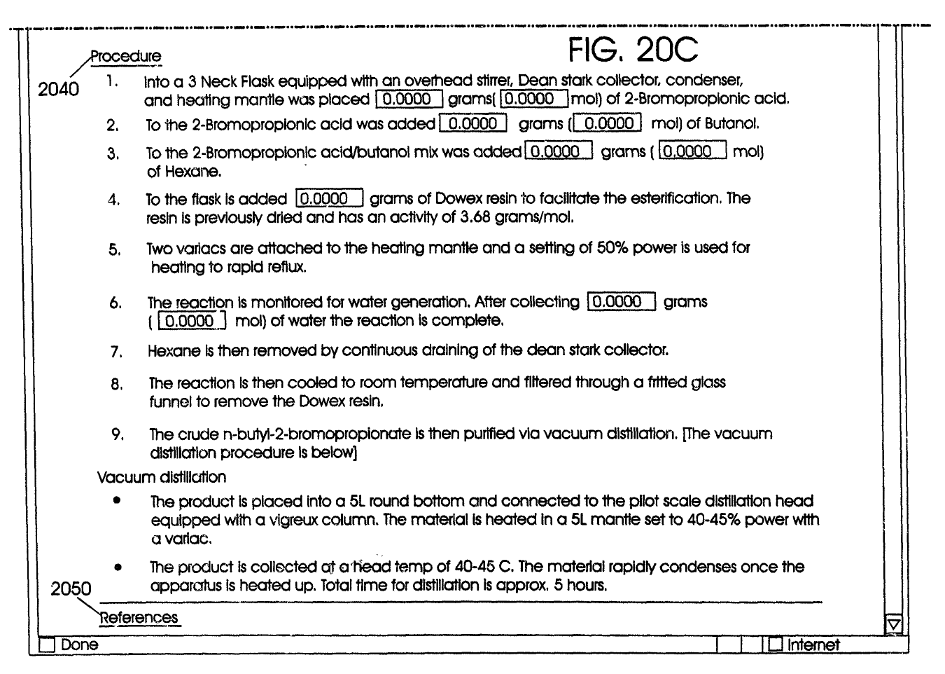

Referring now to Block 1740, a listing of the reagent chemicals, the corresponding equipment and the corresponding procedure is provided, for example as shown in FIG. 20. As shown in FIG. 20, the name of the chemical is displayed at 2010, the reagents are displayed at 2020, the equipment is displayed at 2030, the procedure is displayed at 2040, and the reference that was used to derive the procedure is displayed at 2050.

The operations of FIG. 17 that were described above can facilitate both forward searching and backward searching for target chemicals. In forward searching, a search can be made as to which chemical reactions include a chemical as a reagent. Thus, user identification of a chemical is accepted, and a listing of procedures that use the chemical as a reagent chemical is displayed. A user selection of the procedure from the listing of procedures that use the chemical as a reagent chemical then is accepted. In forward searching, the chemicals attribute of the chemical database 216a of Table 1 may be searched.

In contrast, in backward searching, a search may be made as to how a target chemical may be synthesized. As was described above, in response to selection of a target chemical, a listing of procedures can be displayed that can be used to synthesize the target chemical. A user selection of the procedure is then accepted. In backward searching, the name attribute of the chemical database 216a of Table 1 may be searched.

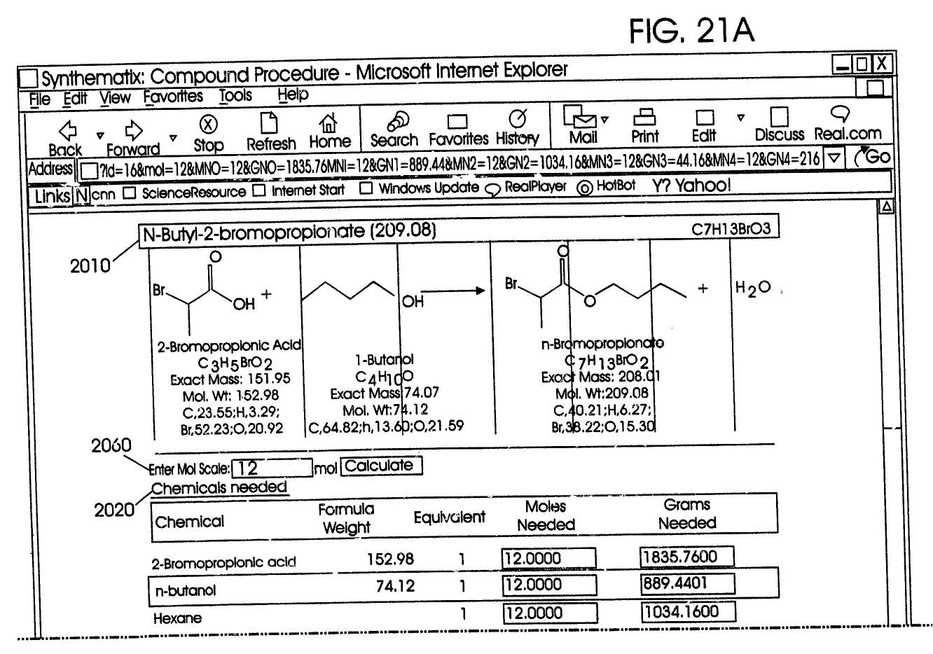

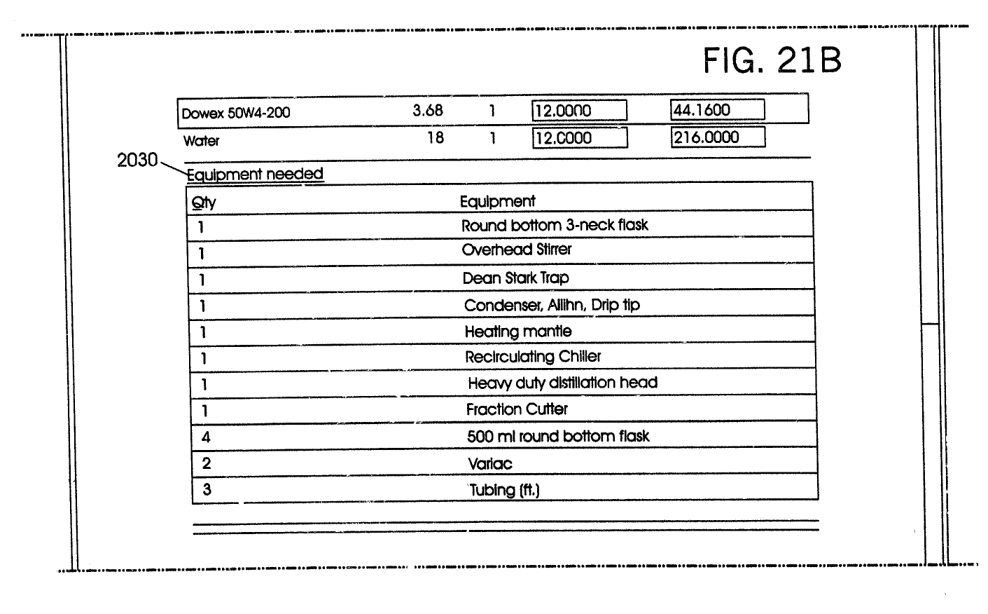

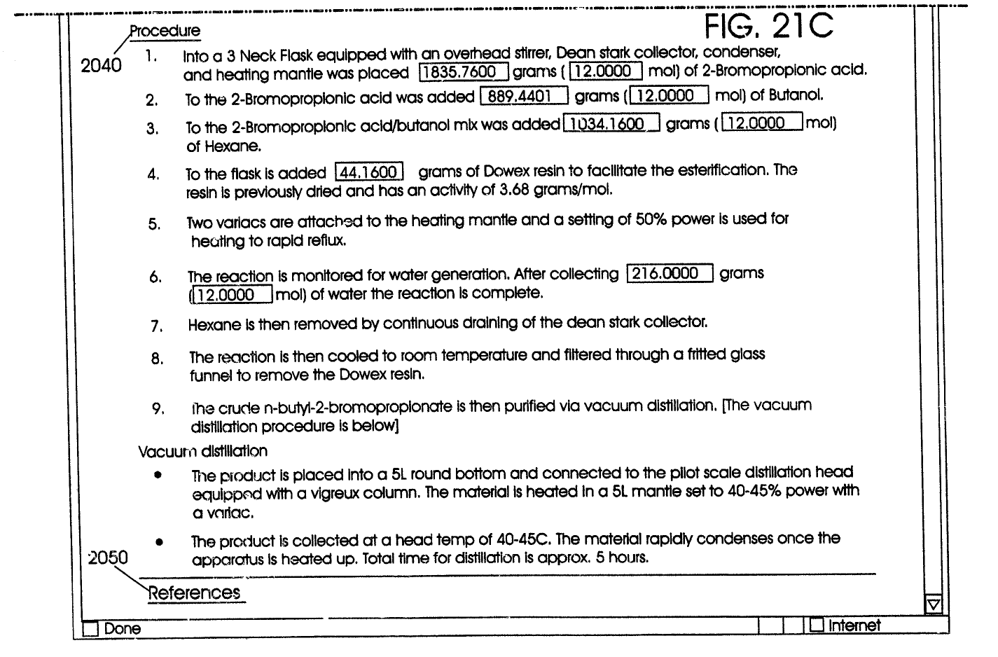

Referring again to FIG. 20, the initial display of FIG. 20 may default to 0 grams or 0 moles of the reagent chemicals and 0 quantities of the equipment. In order to allow synthesis of a desired amount of the target chemical, the user input of a number of moles of the chemical may be input at field 2060, as shown at Block 1742. At Block 1744, the listings of the reagent chemicals and equipment are scaled, so as to synthesize the desired quantity of the target chemical. Then, at Block 1750, a scaled listing of reagent chemicals that are used to synthesize the desired quantity of the target chemical, a listing of equipment that is used to synthesize the desired quantity of the target chemical and a listing of a procedure that is used to synthesize the desired quantity of the target chemical is displayed. FIG. 21 illustrates a display procedure that includes the desired quantities of reagents and equipment. Referring again to FIG. 17, if a customer desires to electronically order the target chemical, reagent chemicals and/or the equipment, the customer proceeds to transaction (Block 130 of FIGS. 1A, 1C-1D and 1G), as will be described in detail below.

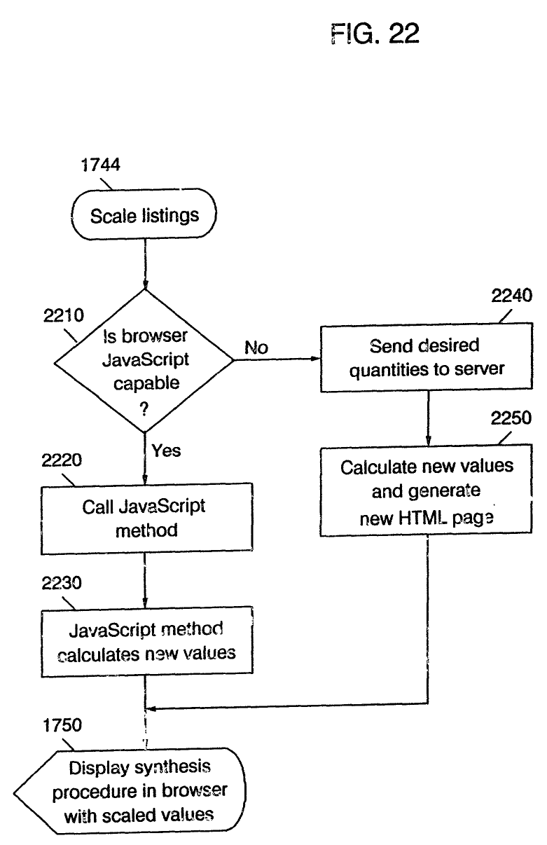

Referring now to FIG. 22, additional details of scaling the listings (Block 1744 of FIG. 17) now will be described. As shown in FIG. 22, the desired quantities may be calculated at the customer site 218 using a browser and/or at the server Web site 212. In particular, as shown at Block 2210, if browser side scripting is supported, for example if the browser is JavaScript-capable, then at Block 2220, the JavaScript method that is specified in the onClick attribute of the Submit button is called. At Block 2230, this JavaScript method calculates the new values and displays them on the Web page at Block 1750. It can return false to stop further processing. It also can provide the values to the server Web site 212 as well.

Returning to Block 2210, if browser side scripting is not supported, then the desired quantity is sent to the server Web site 212 at Block 2240, for example by calling the Uniform Resource Locator (URL) specified in the action attribute of the form page. The server Web site 212 then calculates the new values at Block 2250 and generates a new HTML page at Block 2250, which then is sent back to the customer site 218 for display at Block 1750.

In a specific embodiment, a customer site (client side) JavaScript implementation of the scaler can use the onClick attribute of the HTML tag <input> when the tag also has the attribute type=“submit”. An example snippet is as follows:

<form action=http://someplace.com/formhandler>

<input type=“submit” onClick=“return doSomething( )” >

</form>.

Prior to Netscape Navigator 2.0, the onClick attribute was undefined, so that clicking the Submit button would execute the form action. However, Netscape Navigator 2.0 can cause JavaScript code to be executed prior to calling the action URL defined in the <form>'s action attribute. In Navigator 3.0, the onClick attribute was evaluated for a Boolean (true/false) value. If the value was false, the action URL was not called. Thus, the behavior introduced in Netscape Navigator 3.0 can allow client side only calculation of the scaler value. The calculation can be defined in JavaScript, which is embedded in the HTML page, and referred to this calculation in the onClick attribute.

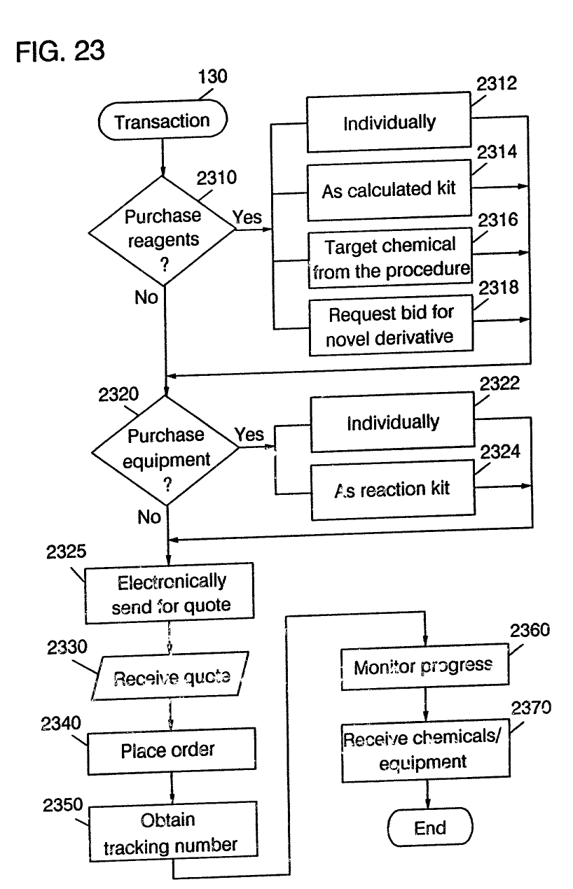

Referring now to FIG. 23, details of performing a transaction (Block 130 of FIGS. 1A, 1C-1D and 1G) now will be described in detail. In general, user input to order reagent chemicals and/or equipment is accepted and the reagent chemicals and/or equipment are electronically ordered. More specifically, as shown in Block 2310, a user input is accepted to purchase reagents. The reagents may be purchased individually (Block 2312) or as a calculated kit (Block 2314). Moreover, the target chemical itself may be purchased directly from a supplier at Block 2316. Finally, if a target chemical is not found in the database, but a derivative thereof is found, a request may be sent to bid on the novel derivative at Block 2318.

Equipment also may be purchased at Block 2320. The equipment may be purchased individually at Block 2322, or as a reaction kit at Block 2324. The supplier database 216c may be used to electronically request a quote at Block 2325 to the supplier sites 222 over the computer network 220 of FIG. 2. A quote then is received at Block 2330, and, if acceptable, an order is placed at Block 2340. The order may be placed by communication over the computer network 220 to the supplier sites 222. A tracking number may be obtained at Block 2350, and the progress of the order may be monitored at Block 2360, for example by providing a private Web page that is generated to match the tracking number of Block 2350. The chemicals and/or equipment then are received at Block 2370.

Other Embodiments

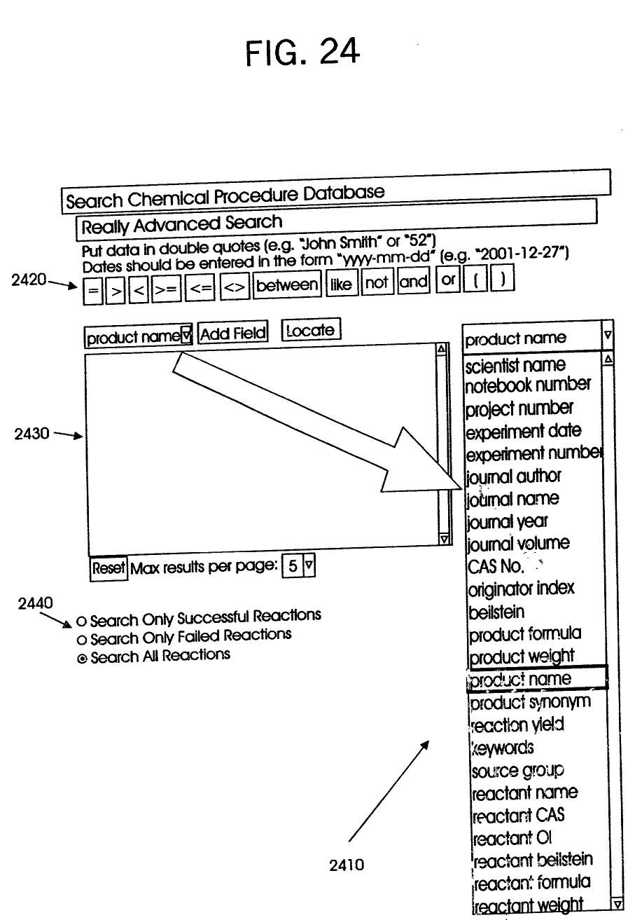

As was described in FIG. 17, embodiments of the present invention may obtain a user identification of a target chemical based on CAS number, chemical name, formula, reaction type, keyword and/or chemical structure. FIG. 18 illustrated an embodiment of a user display that may be used to perform user queries. FIG. 24 illustrates another embodiment of a user display that may be used to accept a user identification of a target chemical by chemical formula, chemical structure, chemical substructure, chemical compound name, CAS number and/or successful/failed reaction according to embodiments of the present invention.

As shown in FIG. 24, a listing 2410 of query fields may be selected from a pull-down menu and a listing of Boolean operators 2420 may be used to build a Boolean query in a Boolean query window 2430. The listing of query fields 2410 may be modified by a user.

Moreover, as shown by selection area 2440, queries also may be performed based only on successful reactions (procedures), based only on failed reactions or based on all reactions. Failed reactions may be identified using the yield field of Table 1 where yield=0. It may be desirable to search only successful reactions in order to increase the likelihood that a selected procedure will provide the desired target chemical. It may be desirable to search only failed reactions in order to identify where prior researchers have been unable to synthesize a target chemical, to identify new areas for possible exploration.

Moreover, according to other embodiments, structures and/or substructures may be used as a search query, alone, in combination with the Boolean search query builder of FIG. 24 and/or in combination with the query display of FIG. 18. In particular, as shown in FIG. 25, a user display for a structure/substructure query can allow the structure/substructure to be drawn and searches of the chemical database 216a to be performed using this structure/substructure. Conventional chemical drawing programs also may be used for the structure/substructure search.

The structure/substructure query display may be based upon a drawing tool that is designed to be useful on a Personal Digital Assistant (PDA) device. It may be particularly useful to use a stylus to click once to obtain a structure. Moreover, highlighting of bonds may facilitate drawing and/or data entry using these types of devices. When used with a PDA, the drawing tool can save drawings at the server 212 for sharing and/or real time on-line collaboration (analogous to an online chemical white board) and/or to save locally.

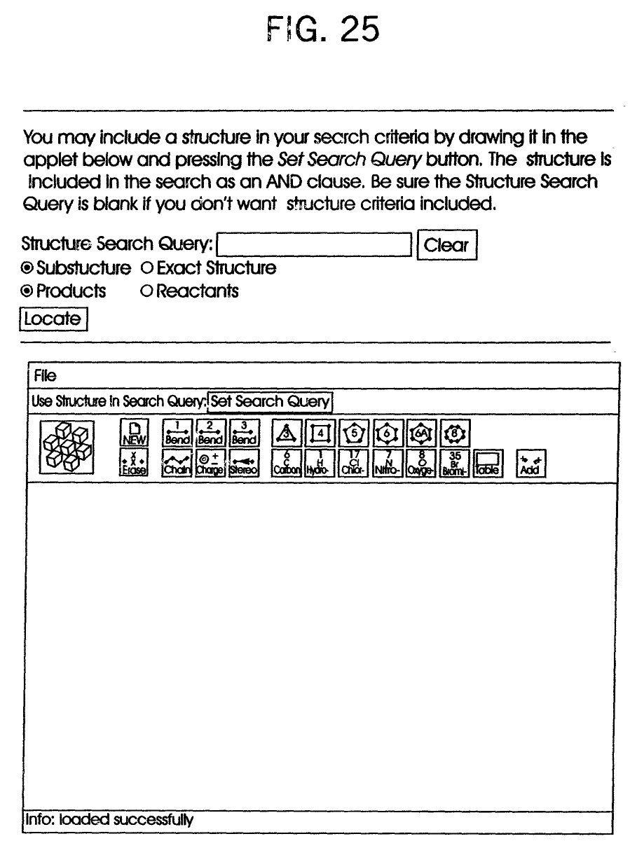

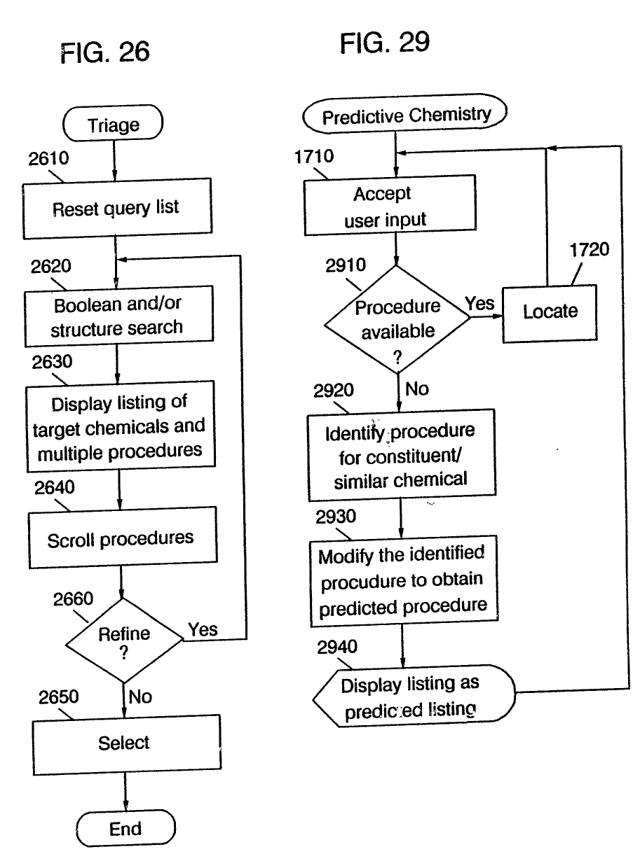

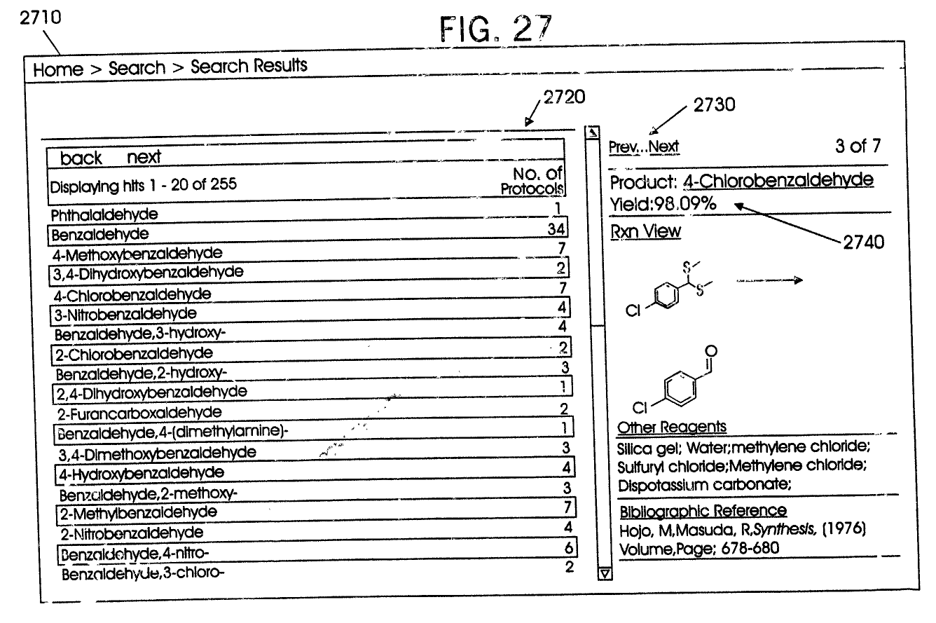

FIGS. 26 and 27 illustrate operations for performing a “reaction triage” to allow rapid screening of large numbers of listings of target chemicals and/or procedures. In particular, these embodiments of the invention can display a list of target chemicals and an indication that a plurality of procedures may be used to synthesize at least one of the target chemicals. A user selection is accepted to scroll a plurality of procedures that may be used to synthesize at least one of the target chemicals. Finally, the user selection of a procedure from a plurality of procedures is accepted.

FIG. 26 is a flowchart illustrating operations for reaction triage according to some embodiments of the present invention. These operations may be used instead of and/or in addition to the locate operations 1720 of FIG. 17.

Referring now to FIG. 26, operations begin at Block 2610 by resetting a query list, if necessary. A Boolean and/or structure search is performed at Block 2620, for example, as was already described above in connection with FIGS. 24 and 25. Then, at Block 2630, a listing of target chemicals and multiple procedures is displayed. FIG. 27 is an example of a user display of a listing 2710 of target chemicals and an indication 2720 that a plurality of procedures (protocols) may be used to synthesize the associated target chemical. In FIG. 27, the number of procedures that may be used to synthesize the target chemical is indicated at 2720. However, other indications may be used. For example, an asterisk may be used to indicate that multiple procedures are available.

Referring again to FIG. 26, at Block 2640 a user selection is accepted to scroll the plurality of procedures that may be used to synthesize an associated target chemical. In particular, a user may click on a target chemical in the listing 2710 and then may click on the previous/next buttons 2730 to scroll through the plurality of procedures. As shown at Block 2660, clicking on the list of target chemicals 2710 and scrolling using the previous/next buttons 2730 may be repeatedly performed in order to refine the identification of a target chemical and a procedure until, at Block 2650, a final user selection of a procedure that can be used to synthesize a target chemical is accepted. The final selection of Block 2650 may take place for example, by selecting the target chemical in the product area 2740 of FIG. 27. Selecting the target chemical in the product area 2740 of FIG. 27 can move processing to the user display of FIG. 20. Moreover, the triage user display of FIG. 27 and the selections within it then can be requeried, for example, using the searching of FIGS. 24 and 25.

It also will be understood that displays of FIG. 20 and/or other user displays that are described herein can be printed for archival purposes. Moreover, embodiments of the invention can add time stamping, user stamping, signature and/or witness lines to the print-out for use in lab notebooks for archival and/or intellectual property protection purposes.

Embodiments of the invention that were described above, for example in connection with FIG. 20, can display the chemical reaction that may be used to synthesize the target chemical from the reagent chemicals as shown, for example, at 2010. Other embodiments of the invention will now be described that can display a reaction flowchart that can provide an overall view of a multi-step reaction to allow searching on connected reactions and/or related syntheses. Thus, according to these embodiments of the invention, a flowchart may be displayed that graphically illustrates first reagent chemicals that are used to synthesize the target chemical, second reagent chemicals that used to synthesize the first reagent chemicals, third reagent chemicals that are used to synthesize the second reagent chemicals, etc. The flowchart also can illustrate procedures that are used to synthesize the second reagent chemicals from the third reagent chemicals, the first reagent chemicals from the second reagent chemicals, the target chemical from the first reagent chemicals, etc. A reaction view therefore may be displayed that proceeds backwards from the target chemical to basic elements and/or proceeds forward from the target chemical to other reactions that use the target chemical.

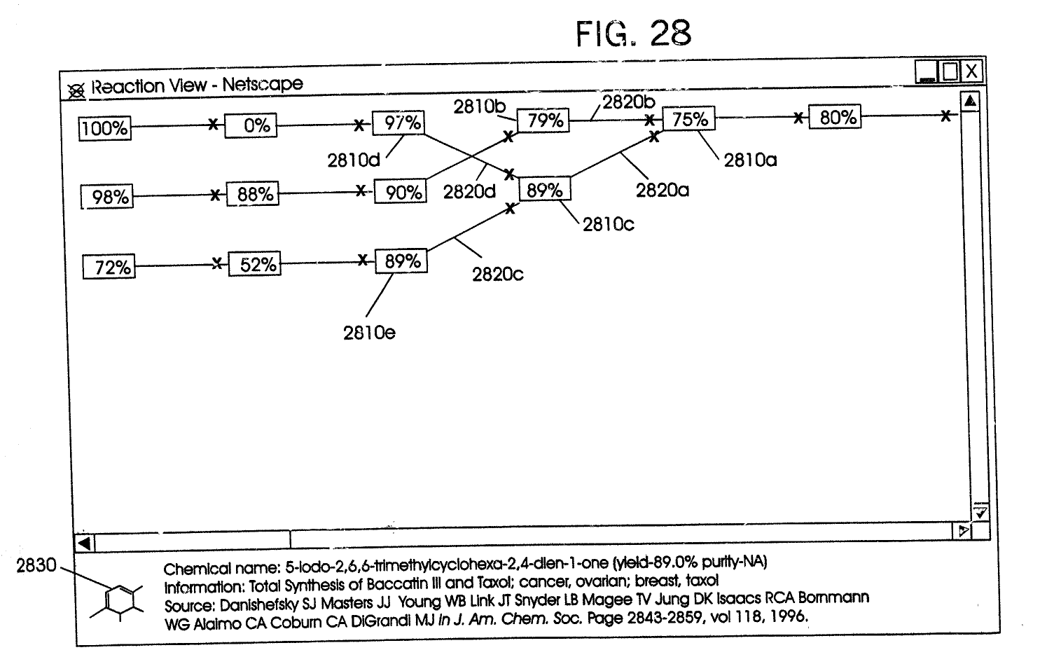

FIG. 28 illustrates an embodiment of a user display for a reaction view flowchart. This example illustrates a sequence of steps for the synthesis of Taxol. User displays of FIG. 28 may be accessed by selecting a “reaction view” button, for example, in FIG. 20.

As shown in FIG. 28, the flowchart comprises a plurality of nodes 2810a-2810e . . . that are linked by branches 2820a-2820d . . . In some embodiments, the nodes correspond to chemicals and the branches correspond to procedures. Thus, in FIG. 28, the node 2810a can correspond to the target chemical, the nodes 2810b and 2810c can correspond to first reagent chemicals, the nodes 2810d and 2810e can correspond to a second reagent chemical, etc. The branches 2820a and 2820b correspond to procedures that are used to synthesize the target chemical 2810a. In other embodiments, the branches can correspond to the target chemical, the first reagent chemicals, the second reagent chemicals, the third reagent chemicals, etc., and the nodes can correspond to the procedures that are used to synthesize the target chemical, the first reagent chemicals, the second reagent chemicals, the third reagent chemicals, etc.

In FIG. 28, the numbers in the blocks indicate yields. A user can mouse over a node 2810 to display a drawing of the chemical and/or other useful information at window 2830. Selecting the window 2830 can move the user directly to a user display of FIG. 20.

In summary, reaction view flowcharts according to embodiments of the invention, such as are illustrated in FIG. 28, may provide flowcharts of nodes and branches wherein the nodes correspond to chemicals and the branches correspond to procedures or the branches correspond to chemicals and the nodes correspond to procedures. These multi-step reaction views can be used to find work-arounds around various portions of a multi-step reaction and/or connections that can be used to bypass various steps. The multi-step reaction view may be built by systems, methods and/or computer program products according to embodiments of the invention, by repeatedly looping over the chemical database 216a using the first pointers of Table 1 until no further records are pointed to.

Chemical data thereby can be visualized by moving forward and/or backward on a reaction tree. A user can navigate forward to see what the reaction product may be used for, and backward to see how the reagents may be made. By obtaining a high-level view of where a reaction lies in space relative to other linked reactions, users can visualize the reaction pathways and the connectivity of reactions.

Referring now to FIGS. 29-31, predictive or guide chemistry according to embodiments of the present invention now will be described. Predictive chemistry can provide systems, methods and/or computer program products for searching for similar reactions while allowing users to plan new reactions based on empirical data in the chemical database 216a. Reactions may be mapped based on similar transformations and/or other historical data. Thus, predictive chemistry may be used in the up-front planning portion of a synthetic procedure by a scientist. This can allow greater “synthetic memory” than may be currently possible.

Referring now to FIG. 29, at Block 1710 a user input of a target chemical is accepted, using any of the techniques that were described above. A determination is then made at Block 2910 as to whether the procedures for synthesizing the target chemical are available in the chemical database 216a. If yes, a locate operation 1720 is performed. However, if an exact match is not found at Block 2910, indicating that a procedure is not available for synthesizing the target chemical, then at Block 2920 a procedure that may be used to synthesize a constituent part of the target chemical and/or a chemical that is similar to the target chemical is identified. At Block 2930, the procedure that may be used to synthesize the constituent part of the target chemical and/or the chemical that is similar to the target chemical is modified to obtain a predicted procedure that may be used to synthesize the target chemical. At Block 2940 a listing of reagent chemicals that may be used to synthesize the target chemical, a listing of equipment that may be used to synthesize the target chemical and a listing of the predicted procedure that may be used to synthesize the target chemical by reacting the reagent chemicals in the equipment according to the predicted procedure, is displayed.

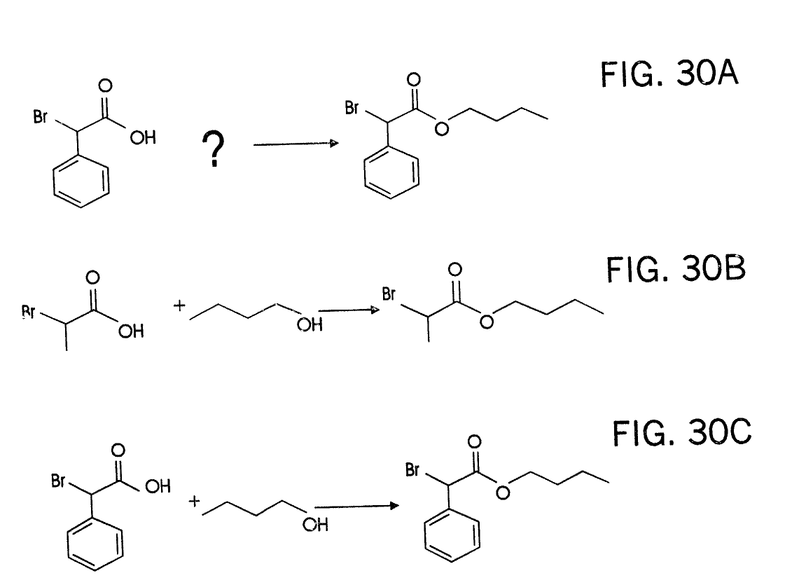

FIGS. 30A-30C illustrate an example of the use of predictive chemistry according to some embodiments of the present invention. As shown in FIG. 30A, an input may be provided by a user (Block 1710 of FIG. 29), for example, by drawing a potential reaction by which a known reagent chemical and an unknown reagent chemical may be used to synthesize a target chemical. If no match for the target chemical of FIG. 30A is found at Block 2910 of FIG. 29, then at Block 2920 of FIG. 29, searches may be made in background for similar structural and/or reactivity factors in the chemical database 216a for reactions that have been performed before. Moreover, if exact matches were found at Block 2910, the user also may be asked whether the user wishes to view other reactions as well.

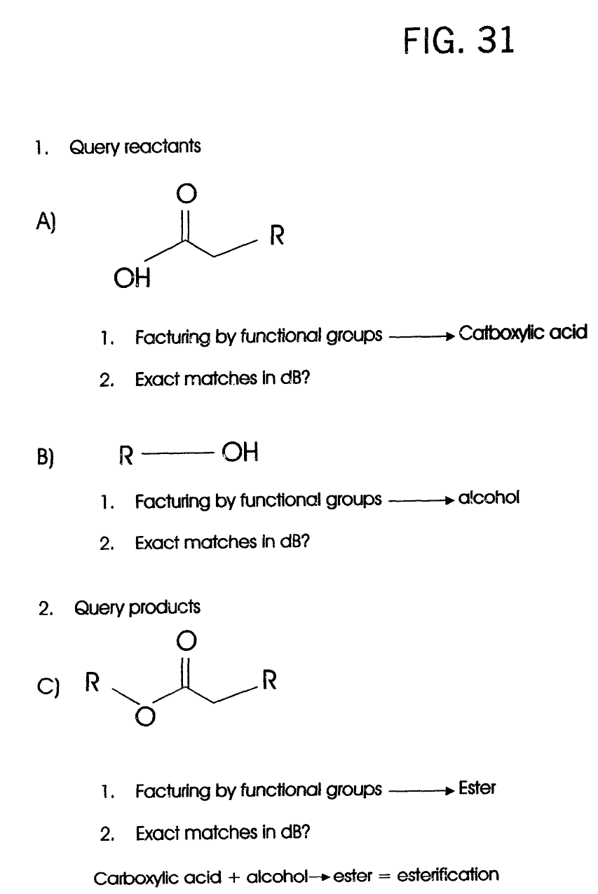

As shown in FIG. 30B, to perform a similar reaction match, embodiments of the invention can use the same substructure system that is used in other searches. Thus, FIG. 30B illustrates a known procedure for synthesizing a target chemical having a structure that is similar to a substructure of the target chemical of FIG. 30A. FIG. 31 provides an example of how a query of reactants and/or products can identify procedures for constituent and/or similar chemicals. Finally, as shown in FIG. 30C, a functional group search and replacement may be made using known intermediates and suggested procedures based upon the data that is stored in the chemical database 216a to thereby modify the identified procedure to obtain a predicted procedure (Block 2930 of FIG. 29).

Thus, these embodiments of the invention can use the experimental procedure and the same reactant ratios as the empirical data. The drawing structures then can be copied over into the empirical template and the amounts can be recalculated. A new reaction is then suggested as a trial based upon the previous knowledge. The data stored in the chemical database 216a therefore may provide an institutional memory that can be used for predictive or guide chemistry to guide scientists to predict parameters for chemical synthesis of a target chemical where no such parameters exist in the chemical database 216a.

In the drawings and specification, there have been disclosed typical preferred embodiments of the invention and, although specific terms are employed, they are used in a generic and descriptive sense only and not for purposes of limitation, the scope of the invention being set forth in the following claims.

What is claimed is:

1. A computerized method of determining parameters for chemical synthesis comprising:
accepting a user identification of a target chemical; and
displaying a listing of reagent chemicals that are used to synthesize the target chemical, a listing of equipment that is used to synthesize the target chemical and a listing of a procedure that is used to synthesize the target chemical by reacting the reagent chemicals in the equipment according to the procedure, in response to the user identification of the target chemical.

2. A method according to claim 1 further comprising:
accepting user input to order the target chemical, the reagent chemicals that are used to synthesize the target chemical and/or the equipment that is used to synthesize the target chemical; and
electronically ordering the target chemical, the reagent chemicals that are used to synthesize the target chemical and/or the equipment that is used to synthesize the target chemical, in response to the user input to order the target chemical, the reagent chemicals that are used to synthesize the target chemical and/or the equipment that is used to synthesize the target chemical.

3. A method according to claim 1 wherein the accepting a user identification of a target chemical is preceded by:
entering into a database, a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure.

4. A method according to claim 3 further comprising:
accepting user input to order the target chemical, the reagent chemicals that are used to synthesize the target chemical and/or the equipment that is used to synthesize the target chemical; and
electronically ordering the target chemical, the reagent chemicals that are used to synthesize the target chemical and/or the equipment that is used to synthesize the target chemical, in response to the user input to order the target chemical, the reagent chemicals that are used to synthesize the target chemical and/or the equipment that is used to synthesize the target chemical.

5. A method according to claim 1 wherein the accepting a user identification of a target chemical comprises accepting a user identification of a target chemical by chemical formula, chemical structure, chemical substructure, chemical compound name, CAS number and/or successful/failed reactions.

6. A method according to claim 1 wherein the accepting a user identification of a target chemical comprises:
displaying a listing of target chemicals that match the user query; and
accepting a user selection of a target chemical from the listing of target chemicals that match the user query.

7. A method according to claim 1 wherein the accepting a user identification of a target chemical comprises:
accepting a user identification of a reaction type;
displaying a listing of target chemicals that are synthesized using the reaction type; and
accepting a user selection of a target chemical from the listing of target chemicals that are synthesized using the reaction type.

8. A method according to claim 1 wherein the following is performed between the accepting and the displaying:
displaying a listing of procedures that can be used to synthesize the target chemical; and
accepting a user selection of a procedure from the listing of procedures that can be used to synthesize the target chemical.

9. A method according to claim 1 wherein the following is performed between the accepting and the displaying:
accepting a user selection of a desired quantity of the target chemical; and
scaling the listing of the reagent chemicals so as to synthesize the desired quantity of the target chemical; and
wherein the displaying comprises:
displaying a scaled listing of the reagent chemicals that are used to synthesize the desired quantity of the target chemical, a listing of equipment that is used to synthesize the desired quantity of the target chemical and a listing of a procedure that is used to synthesize the desired quantity of the target chemical by reacting the reagent chemicals in the equipment according to the procedure, in response to the user identification of the target chemical and the user selection of the desired quantity of the target chemical.

10. A method according to claim 1 wherein the accepting a user identification of a target chemical comprises:
displaying a prioritized listing of target chemicals that match the user query; and
accepting a user selection of a target chemical from the prioritized listing of target chemicals that match the user query.

11. A method according to claim 1 wherein the accepting a user identification of a target chemical comprises:
accepting user identification of a chemical;
displaying a listing of procedures that use the chemical as a reagent chemical; and
accepting a user selection of a procedure from the listing of procedures that use the chemical as a reagent chemical.

12. A method according to claim 1 wherein the accepting a user identification of a target chemical comprises:
displaying a list of target chemicals and an indication that a plurality of procedures may be used to synthesize at least one of the target chemicals;
accepting a user selection to scroll the plurality of procedures that may be used to synthesize at least one of the target chemicals; and
accepting a user selection of a procedure from the plurality of procedures that can be used to synthesize at least one of the target chemicals.

13. A method according to claim 1 wherein the displaying comprises:
displaying a flowchart that graphically indicates first reagent chemicals that are used to synthesize the target chemical, second reagent chemicals that are used to synthesize the first reagent chemicals, third reagent chemicals that are used to synthesize the second reagent chemicals and procedures that are used to synthesize the second reagent chemicals from the third reagent chemicals, the first reagent chemicals from the second reagent chemicals and the target chemical from the first reagent chemicals.

14. A method according to claim 13 wherein the flowchart comprises a plurality of nodes that are linked by branches, a respective node corresponding to the target chemical, a first reagent chemical, a second reagent chemical or a third reagent chemical, a respective branch corresponding to a procedure that is used to synthesize the target chemical, the first reagent chemical, the second reagent chemical or the third reagent chemical that corresponds to a node that is linked to the respective branch.

15. A method according to claim 13 wherein the flowchart comprises a plurality of nodes that are linked by branches, a respective branch corresponding to the target chemical, a first reagent chemical, a second reagent chemical or a third reagent chemical, a respective node corresponding to a procedure that is used to synthesize the target chemical, the first reagent chemical, the second reagent chemical or the third reagent chemical that corresponds to a branch that is linked to the respective node.

16. A method according to claim 1 wherein the following is performed between the accepting and the displaying:
determining that a procedure is not available for synthesizing the target chemical;
identifying a procedure that may be used to synthesize a constituent part of the target chemical and/or a chemical that is similar to the target chemical; and
modifying the procedure that may be used to synthesize the constituent part of the target chemical and/or the chemical that is similar to the target chemical to obtain a predicted procedure that may be used to synthesize the target chemical; and
wherein the displaying comprises displaying a listing of reagent chemicals that may be used to synthesize the target chemical, a listing of equipment that may be used to synthesize the target chemical and a listing of the predicted procedure that may be used to synthesize the target chemical by reacting the reagent chemicals in the equipment according to the predicted procedure, in response to the user identification of the target chemical.

17. A computerized method of determining parameters for chemical synthesis comprising:
entering into a database, a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure.

18. A method according to claim 17 further comprising:
accepting user input to order one of the target chemicals, reagent chemicals that are used to synthesize the one of the target chemicals and/or equipment that is used to synthesize the one of the target chemicals; and
electronically ordering the one of the target chemicals, the reagent chemicals that are used to synthesize the one of the target chemicals and/or the equipment that is used to synthesize the one of the target chemicals, in response to the user input to order the one of the target chemicals, the reagent chemicals that are used to synthesize the one of the target chemicals and/or the equipment that is used to synthesize the one of the target chemicals.

19. A method according to claim 17 wherein the entering comprises interactively entering into the database a narrative description of steps of the corresponding procedure using the corresponding listing of the reagent chemicals and the corresponding listing of the equipment.

20. A method according to claim 17 wherein the entering comprises accepting user entry of a listing of reagent chemicals that are used in a next step of a procedure to synthesize a target chemical, user entry of a listing of corresponding equipment that is used in the next step of the procedure to synthesize the target chemical and user entry of the next step of the procedure to synthesize the target chemical, in response to user indication that the next step is present in the procedure.

21. A method according to claim 17 wherein the entering is preceded by identifying a target chemical, reagent chemicals that are used to synthesize the target chemical, equipment that is used to synthesize the target chemical and a procedure that is used to synthesize the target chemical by reacting the reagent chemicals in the equipment according to the procedure, from a publication related to synthesis of the target chemical and/or from proprietary data related to synthesis of the target chemical.

22. A method according to claim 17 wherein the entering comprises:
entering into a chemical database, a plurality of target chemicals, a plurality of first pointers to a corresponding plurality of listings of reagent chemicals in the chemical database that are used to synthesize the plurality of target chemicals, a plurality of second pointers to a corresponding plurality of listings of equipment in an equipment database that is used to synthesize the plurality of target chemicals, and a plurality of corresponding listings of procedures that are used to synthesize the plurality of target chemicals by reacting the corresponding reagent chemicals in the corresponding equipment according to the corresponding procedure; and
entering into the equipment database, the plurality of listings of equipment that is used to synthesize the plurality of target chemicals.

23. A computerized method of obtaining materials for chemical synthesis comprising:
electronically ordering a target chemical, reagent chemicals that are used to synthesize the target chemical and/or equipment that is used to synthesize the target chemical, from an electronically displayed listing of the reagent chemicals that are used to synthesize the target chemical, of the equipment that is used to synthesize the target chemical and of a procedure that is used to synthesize the target chemical by reacting the reagent chemicals in the equipment according to the procedure, in response to user input to order the target chemical, the reagent chemicals that are used to synthesize the target chemical and/or the equipment that is used to synthesize the target chemical.

24. A method according to claim 23 wherein the electronically ordering comprises:
electronically ordering a kit of the reagent chemicals that are used to synthesize the target chemical.

25. A method according to claim 23 wherein the electronically ordering comprises:
electronically ordering a kit of the equipment that is used to synthesize the target chemical.

26. A chemical synthesis data structure comprising:
a chemical database comprising a plurality of listings of target chemicals, a plurality of first pointers to a corresponding plurality of listings of reagent chemicals in the chemical database that are used to synthesize the plurality of target chemicals, a plurality of second pointers to a corresponding plurality of listings of equipment in an equipment database that is used to synthesize the plurality of target chemicals, and a plurality of corresponding listings of procedures that are used to synthesize the plurality of target chemicals by reacting the corresponding reagent chemicals in the corresponding equipment according to the corresponding procedure; and
an equipment database comprising the plurality of second pointers and the plurality of corresponding listings of equipment that is used to synthesize the plurality of target chemicals.

27. A data structure according to claim 26 wherein the equipment database further comprises a plurality of third pointers to a corresponding plurality of listings of equipment suppliers in an equipment supplier database, the data structure further comprising:
a supplier database that comprises the plurality of third pointers and the plurality of corresponding listings of the equipment suppliers of the equipment that is used to synthesize the plurality of target chemicals.

28. A data structure according to claim 26 wherein the listings of target chemicals and the listings of reagent chemicals comprise portions of a single listing of chemicals.

29. A system for determining parameters for chemical synthesis comprising:
means for accepting a user identification of a target chemical; and
means for displaying a listing of reagent chemicals that are used to synthesize the target chemical, a listing of equipment that is used to synthesize the target chemical and a listing of a procedure that is used to synthesize the target chemical by reacting the reagent chemicals in the equipment according to the procedure, in response to the user identification of the target chemical.

30. A system according to claim 29 further comprising:
means for accepting user input to order the target chemical, the reagent chemicals that are used to synthesize the target chemical and/or the equipment that is used to synthesize the target chemical; and
means for electronically ordering the target chemical, the reagent chemicals that are used to synthesize the target chemical and/or the equipment that is used to synthesize the target chemical, in response to the user input to order the target chemical, the reagent chemicals that are used to synthesize the target chemical and/or the equipment that is used to synthesize the target chemical.

31. A system according to claim 29 further comprising:
a database; and
means for entering into the database, a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure.

32. A system according to claim 31 further comprising:
means for accepting user input to order the target chemical, the reagent chemicals that are used to synthesize the target chemical and/or the equipment that is used to synthesize the target chemical; and
means for electronically ordering the target chemical, the reagent chemicals that are used to synthesize the target chemical and/or the equipment that is used to synthesize the target chemical, in response to the user input to order the target chemical, the reagent chemicals that are used to synthesize the target chemical and/or the equipment that is used to synthesize the target chemical.

33. A system according to claim 29 wherein the means for accepting a user identification of a target chemical comprises means for accepting a user identification of a target chemical by chemical formula, chemical structure, chemical substructure, chemical compound name, CAS number and/or successful/failed reactions.

34. A system according to claim 29 wherein the means for accepting a user identification of a target chemical comprises:
means for displaying a listing of target chemicals that match the user query; and
means for accepting a user selection of a target chemical from the listing of target chemicals that match the user query.

35. A system according to claim 29 wherein the means for accepting a user identification of a target chemical comprises:
means for accepting a user identification of a reaction type;
means for displaying a listing of target chemicals that are synthesized using the reaction type; and
means for accepting a user selection of a target chemical from the listing of target chemicals that are synthesized using the reaction type.

36. A system according to claim 29 further comprising:
means for displaying a listing of procedures that can be used to synthesize the target chemical; and
means for accepting a user selection of a procedure from the listing of procedures that can be used to synthesize the target chemical.

37. A system according to claim 29 further comprising:
means for accepting a user selection of a desired quantity of the target chemical; and
means for scaling the listing of the reagent chemicals so as to synthesize the desired quantity of the target chemical; and
wherein the means for displaying comprises:
means for displaying a scaled listing of the reagent chemicals that are used to synthesize the desired quantity of the target chemical, a listing of equipment that is used to synthesize the desired quantity of the target chemical and a listing of a procedure that is used to synthesize the desired quantity of the target chemical by reacting the reagent chemicals in the equipment according to the procedure, in response to the user identification of the target chemical and the user selection of the desired quantity of the target chemical.

38. A system according to claim 29 wherein the means for accepting a user identification of a target chemical comprises:
means for displaying a prioritized listing of target chemicals that match the user query; and
means for accepting a user selection of a target chemical from the prioritized listing of target chemicals that match the user query.

39. A system according to claim 29 wherein the means for accepting a user identification of a target chemical comprises:
means for accepting user identification of a chemical;
means for displaying a listing of procedures that use the chemical as a reagent chemical; and
means for accepting a user selection of a procedure from the listing of procedures that use the chemical as a reagent chemical.

40. A system according to claim 29 wherein the means for accepting a user identification of a target chemical comprises:
means for displaying a list of target chemicals and an indication that a plurality of procedures may be used to synthesize at least one of the target chemicals;
means for accepting a user selection to scroll the plurality of procedures that may be used to synthesize at least one of the target chemicals; and
means for accepting a user selection of a procedure from the plurality of procedures that can be used to synthesize at least one of the target chemicals.

41. A system according to claim 29 wherein the means for displaying comprises:
means for displaying a flowchart that graphically indicates first reagent chemicals that are used to synthesize the target chemical, second reagent chemicals that are used to synthesize the first reagent chemicals, third reagent chemicals that are used to synthesize the second reagent chemicals and procedures that are used to synthesize the second reagent chemicals from the third reagent chemicals, the first reagent chemicals from the second reagent chemicals and the target chemical from the first reagent chemicals.

42. A system according to claim 41 wherein the flowchart comprises a plurality of nodes that are linked by branches, a respective node corresponding to the target chemical, a first reagent chemical, a second reagent chemical or a third reagent chemical, a respective branch corresponding to a procedure that is used to synthesize the target chemical, the first reagent chemical, the second reagent chemical or the third reagent chemical that corresponds to a node that is linked to the respective branch.

43. A system according to claim 41 wherein the flowchart comprises a plurality of nodes that are linked by branches, a respective branch corresponding to the target chemical, a first reagent chemical, a second reagent chemical or a third reagent chemical, a respective node corresponding to a procedure that is used to synthesize the target chemical, the first reagent chemical, the second reagent chemical or the third reagent chemical that corresponds to a branch that is linked to the respective node.

44. A system according to claim 29 further comprising:
means for determining that a procedure is not available for synthesizing the target chemical;
means for identifying a procedure that may be used to synthesize a constituent part of the target chemical and/or a chemical that is similar to the target chemical; and
means for modifying the procedure that may be used to synthesize the constituent part of the target chemical and/or the chemical that is similar to the target chemical to obtain a predicted procedure that may be used to synthesize the target chemical; and
wherein the means for displaying comprises means for displaying a listing of reagent chemicals that may be used to synthesize the target chemical, a listing of equipment that may be used to synthesize the target chemical and a listing of the predicted procedure that may be used to synthesize the target chemical by reacting the reagent chemicals in the equipment according to the predicted procedure, in response to the user identification of the target chemical.

45. A system for determining parameters for chemical synthesis comprising:
a database; and
means for entering into the database, a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure.

46. A system according to claim 45 further comprising:
means for accepting user input to order one of the target chemicals, reagent chemicals that are used to synthesize the one of the target chemicals and/or equipment that is used to synthesize the one of the target chemicals; and
means for electronically ordering the one of the target chemicals, the reagent chemicals that are used to synthesize the one of the target chemicals and/or the equipment that is used to synthesize the one of the target chemicals, in response to the user input to order the one of the target chemicals, the reagent chemicals that are used to synthesize the one of the target chemicals and/or the equipment that is used to synthesize the one of the target chemicals.

47. A system according to claim 45 wherein the means for entering comprises means for interactively entering into the database a narrative description of steps of the corresponding procedure using the corresponding listing of the reagent chemicals and the corresponding listing of the equipment.

48. A system according to claim 45 wherein the means for entering comprises means for accepting user entry of a listing of reagent chemicals that are used in a next step of a procedure to synthesize a target chemical, user entry of a listing of corresponding equipment that is used in the next step of the procedure to synthesize the target chemical and user entry of the next step of the procedure to synthesize the target chemical, in response to user indication that the next step is present in the procedure.

49. A system according to claim 45 further comprising means for identifying a target chemical, reagent chemicals that are used to synthesize the target chemical, equipment that is used to synthesize the target chemical and a procedure that is used to synthesize the target chemical by reacting the reagent chemicals in the equipment according to the procedure, from a publication related to synthesis of the target chemical and/or from proprietary data related to synthesis of the target chemical.

50. A system according to claim 45 wherein the database comprises a chemical database and an equipment database, and the means for entering comprises:
means for entering into the chemical database, a plurality of target chemicals, a plurality of first pointers to a corresponding plurality of listings of reagent chemicals in the chemical database that are used to synthesize the plurality of target chemicals, a plurality of second pointers to a corresponding plurality of listings of equipment in the equipment database that is used to synthesize the plurality of target chemicals, and a plurality of corresponding listings of procedures that are used to synthesize the plurality of target chemicals by reacting the corresponding reagent chemicals in the corresponding equipment according to the corresponding procedure; and
means for entering into the equipment database, the plurality of listings of equipment that is used to synthesize the plurality of target chemicals.

51. A system for obtaining materials for chemical synthesis comprising:
an electronically displayed listing of reagent chemicals that are used to synthesize a target chemical, of equipment that is used to synthesize the target chemical and of a procedure that is used to synthesize the target chemical by reacting the reagent chemicals in the equipment according to the procedure; and
means for electronically ordering the target chemical, the reagent chemicals that are used to synthesize the target chemical and/or the equipment that is used to synthesize the target chemical, from the electronically displayed listing of the reagent chemicals that are used to synthesize the target chemical, of the equipment that is used to synthesize the target chemical and of the procedure that is used to synthesize the target chemical by reacting the reagent chemicals in the equipment according to the procedure, in response to user input to order the target chemical, the reagent chemicals that are used to synthesize the target chemical and/or the equipment that is used to synthesize the target chemical.

52. A system according to claim 51 wherein the means for electronically ordering comprises:
means for electronically ordering a kit of the reagent chemicals that are used to synthesize the target chemical.

53. A system according to claim 51 wherein the means for electronically ordering comprises:
means for electronically ordering a kit of the equipment that is used to synthesize the target chemical.

54. A computer program product that determines parameters for chemical synthesis, the computer program product comprising a computer usable storage medium having computer-readable program code embodied in the medium, the computer-readable program code comprising:
computer-readable program code that is configured to accept a user identification of a target chemical; and
computer-readable program code that is configured to display a listing of reagent chemicals that are used to synthesize the target chemical, a listing of equipment that is used to synthesize the target chemical and a listing of a procedure that is used to synthesize the target chemical by reacting the reagent chemicals in the equipment according to the procedure, in response to the user identification of the target chemical.

55. A computer program product according to claim 54 further comprising:
computer-readable program code that is configured to accept user input to order the target chemical, the reagent chemicals that are used to synthesize the target chemical and/or the equipment that is used to synthesize the target chemical; and
computer-readable program code that is configured to electronically order the target chemical, the reagent chemicals that are used to synthesize the target chemical and/or the equipment that is used to synthesize the target chemical, in response to the user input to order the target chemical, the reagent chemicals that are used to synthesize the target chemical and/or the equipment that is used to synthesize the target chemical.

56. A computer program product according to claim 54 further comprising:
computer-readable program code that is configured to enter into a database, a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure.

57. A computer program product according to claim 56 further comprising:
computer-readable program code that is configured to accept user input to order the target chemical, the reagent chemicals that are used to synthesize the target chemical and/or the equipment that is used to synthesize the target chemical; and
computer-readable program code that is configured to electronically order the target chemical, the reagent chemicals that are used to synthesize the target chemical and/or the equipment that is used to synthesize the target chemical, in response to the user input to order the target chemical, the reagent chemicals that are used to synthesize the target chemical and/or the equipment that is used to synthesize the target chemical.

58. A computer program product according to claim 54 wherein the computer-readable program code that is configured to accept a user identification of a target chemical comprises computer-readable program code that is configured to accept a user identification of a target chemical by chemical formula, chemical structure, chemical substructure, chemical compound name, CAS number and/or successful/failed reactions.

59. A computer program product according to claim 54 wherein the computer-readable program code that is configured to accept a user identification of a target chemical comprises:
computer-readable program code that is configured to display a listing of target chemicals that match the user query; and
computer-readable program code that is configured to accept a user selection of a target chemical from the listing of target chemicals that match the user query.

60. A computer program product according to claim 54 wherein the computer-readable program code that is configured to accept a user identification of a target chemical comprises:
computer-readable program code that is configured to accept a user identification of a reaction type;
computer-readable program code that is configured to display a listing of target chemicals that are synthesized using the reaction type; and
computer-readable program code that is configured to accept a user selection of a target chemical from the listing of target chemicals that are synthesized using the reaction type.

61. A computer program product according to claim 54 further comprising:
computer-readable program code that is configured to display a listing of procedures that can be used to synthesize the target chemical; and
computer-readable program code that is configured to accept a user selection of a procedure from the listing of procedures that can be used to synthesize the target chemical.

62. A computer program product according to claim 54 further comprising:
computer-readable program code that is configured to accept a user selection of a desired quantity of the target chemical; and
computer-readable program code that is configured to scale the listing of the reagent chemicals so as to synthesize the desired quantity of the target chemical; and
wherein the computer-readable program code that is configured to display comprises:
computer-readable program code that is configured to display a scaled listing of the reagent chemicals that are used to synthesize the desired quantity of the target chemical, a listing of equipment that is used to synthesize the desired quantity of the target chemical and a listing of a procedure that is used to synthesize the desired quantity of the target chemical by reacting the reagent chemicals in the equipment according to the procedure, in response to the user identification of the target chemical and the user selection of the desired quantity of the target chemical.

63. A computer program product according to claim 54 wherein the computer-readable program code that is configured to accept a user identification of a target chemical comprises:
computer-readable program code that is configured to display a prioritized listing of target chemicals that match the user query; and
computer-readable program code that is configured to accept a user selection of a target chemical from the prioritized listing of target chemicals that match the user query.

64. A computer program product according to claim 54 wherein the computer-readable program code that is configured to accept a user identification of a target chemical comprises:
computer-readable program code that is configured to accept user identification of a chemical;
computer-readable program code that is configured to display a listing of procedures that use the chemical as a reagent chemical; and
computer-readable program code that is configured to accept a user selection of a procedure from the listing of procedures that use the chemical as a reagent chemical.

65. A computer program product according to claim 54 wherein the computer-readable program code that is configured to accept a user identification of a target chemical comprises:
computer-readable program code that is configured to display a list of target chemicals and an indication that a plurality of procedures may be used to synthesize at least one of the target chemicals;
computer-readable program code that is configured to accept a user selection to scroll the plurality of procedures that may be used to synthesize at least one of the target chemicals; and
computer-readable program code that is configured to accept a user selection of a procedure from the plurality of procedures that can be used to synthesize at least one of the target chemicals.

66. A computer program product according to claim 54 wherein the computer-readable program code that is configured to display comprises:
computer-readable program code that is configured to display a flowchart that graphically indicates first reagent chemicals that are used to synthesize the target chemical, second reagent chemicals that are used to synthesize the first reagent chemicals, third reagent chemicals that are used to synthesize the second reagent chemicals and procedures that are used to synthesize the second reagent chemicals from the third reagent chemicals, the first reagent chemicals from the second reagent chemicals and the target chemical from the first reagent chemicals.

67. A computer program product according to claim 66 wherein the flowchart comprises a plurality of nodes that are linked by branches, a respective node corresponding to the target chemical, a first reagent chemical, a second reagent chemical or a third reagent chemical, a respective branch corresponding to a procedure that is used to synthesize the target chemical, the first reagent chemical, the second reagent chemical or the third reagent chemical that corresponds to a node that is linked to the respective branch.

68. A computer program product according to claim 66 wherein the flowchart comprises a plurality of nodes that are linked by branches, a respective branch corresponding to the target chemical, a first reagent chemical, a second reagent chemical or a third reagent chemical, a respective node corresponding to a procedure that is used to synthesize the target chemical, the first reagent chemical, the second reagent chemical or the third reagent chemical that corresponds to a branch that is linked to the respective node.

69. A computer program product according to claim 54 further comprising:
computer-readable program code that is configured to determine that a procedure is not available for synthesizing the target chemical;
computer-readable program code that is configured to identify a procedure that may be used to synthesize a constituent part of the target chemical and/or a chemical that is similar to the target chemical; and
computer-readable program code that is configured to modify the procedure that may be used to synthesize the constituent part of the target chemical and/or the chemical that is similar to the target chemical to obtain a predicted procedure that may be used to synthesize the target chemical; and
wherein the computer-readable program code that is configured to display comprises computer-readable program code that is configured to display a listing of reagent chemicals that may be used to synthesize the target chemical, a listing of equipment that may be used to synthesize the target chemical and a listing of the predicted procedure that may be used to synthesize the target chemical by reacting the reagent chemicals in the equipment according to the predicted procedure, in response to the user identification of the target chemical.

70. A computer program product that determines parameters for chemical synthesis, the computer program product comprising a computer usable storage medium having computer-readable program code embodied in the medium, the computer-readable program code comprising:
computer-readable program code that is configured to enter into a database, a plurality of target chemicals, a plurality of corresponding listings of reagent chemicals that are used to synthesize the plurality of target chemicals, a plurality of corresponding listings of equipment that is used to synthesize the plurality of target chemicals and a plurality of corresponding listings of procedures that are used to synthesize the plurality of target chemicals by reacting the corresponding reagent chemicals in the corresponding equipment according to the corresponding procedure.

71. A computer program product according to claim 70 further comprising:
computer-readable program code that is configured to accept user input to order one of the target chemicals, reagent chemicals that are used to synthesize the one of the target chemicals and/or equipment that is used to synthesize the one of the target chemicals; and
computer-readable program code that is configured to electronically order the one of the target chemicals, the reagent chemicals that are used to synthesize the one of the target chemicals and/or the equipment that is used to synthesize the one of the target chemicals, in response to the user input to order the one of the target chemicals, the reagent chemicals that are used to synthesize the one of the target chemicals and/or the equipment that is used to synthesize the one of the target chemicals.

72. A computer program product according to claim 70 wherein the computer-readable program code that is configured to enter comprises computer-readable program code that is configured to interactively enter into the database a narrative description of steps of the corresponding procedure using the corresponding listing of the reagent chemicals and the corresponding listing of the equipment.

73. A computer program product according to claim 70 wherein the computer-readable program code that is configured to enter comprises computer-readable program code that is configured to accept user entry of a listing of reagent chemicals that are used in a next step of a procedure to synthesize a target chemical, user entry of a listing of corresponding equipment that is used in the next step of the procedure to synthesize the target chemical and user entry of the next step of the procedure to synthesize the target chemical, in response to user indication that the next step is present in the procedure.

74. A computer program product according to claim 70 further comprising:
computer-readable program code that is configured to identify a target chemical, reagent chemicals that are used to synthesize the target chemical, equipment that is used to synthesize the target chemical and a procedure that is used to synthesize the target chemical by reacting the reagent chemicals in the equipment according to the procedure, from a publication related to synthesis of the target chemical and/or from proprietary data related to synthesis of the target chemical.

75. A method according to claim 70 wherein the computer-readable program code that is configured to enter comprises:
computer-readable program code that is configured to enter into a chemical database, a plurality of target chemicals, a plurality of first pointers to a corresponding plurality of listings of reagent chemicals in the chemical database that are used to synthesize the plurality of target chemicals, a plurality of second pointers to a corresponding plurality of listings of equipment in an equipment database that is used to synthesize the plurality of target chemicals, and a plurality of corresponding listings of procedures that are used to synthesize the plurality of target chemicals by reacting the corresponding reagent chemicals in the corresponding equipment according to the corresponding procedure; and
computer-readable program code that is configured to enter into the equipment database, the plurality of listings of equipment that is used to synthesize the plurality of target chemicals.

76. A computer program product that obtains materials for chemical synthesis, the computer program product comprising a computer usable storage medium having computer-readable program code embodied in the medium, the computer-readable program code comprising:
computer-readable program code that is configured to electronically order a target chemical, reagent chemicals that are used to synthesize the target chemical and/or equipment that is used to synthesize the target chemical, from an electronically displayed listing of the reagent chemicals that are used to synthesize the target chemical, of the equipment that is used to synthesize the target chemical and of a procedure that is used to synthesize the target chemical by reacting the reagent chemicals in the equipment according to the procedure, in response to user input to order the target chemical, the reagent chemicals that are used to synthesize the target chemical and/or the equipment that is used to synthesize the target chemical.

77. A computer program product according to claim 76 wherein the computer-readable program code that is configured to electronically order comprises:
computer-readable program code that is configured to electronically order a kit of the reagent chemicals that are used to synthesize the target chemical.

78. A computer program product according to claim 76 wherein the computer-readable program code that is configured to electronically order comprises:
computer-readable program code that is configured to electronically order a kit of the equipment that is used to synthesize the target chemical.
